(19) United States
(12) Patent Application Publication
(10) Pub. No.: US 2023/0326024 A1
(43) Pub. Date: Oct. 12, 2023

(54) MULTIMODAL PREDICTION OF GEOGRAPHIC ATROPHY GROWTH RATE

(71) Applicant: Genentech, Inc., South San Francisco, CA (US)

(72) Inventors: Qi YANG, Foster City, CA (US); Neha Sutheekshna ANEGONDI, Fremont, CA (US); Simon Shang GAO, San Francisco, CA (US)

(21) Appl. No.: 18/328,305

(22) Filed: Jun. 2, 2023

Related U.S. Application Data
(63) Continuation of application No. PCT/US2021/061606, filed on Dec. 2, 2021.
(60) Provisional application No. 63/121,125, filed on Dec. 3, 2020.
(60) Provisional application No. 63/169,764, filed on Apr. 1, 2021.
(60) Provisional application No. 63/181,813, filed on Apr. 29, 2021.
(60) Provisional application No. 63/218,905, filed on Jul. 6, 2021.

(51) Int. Cl. G06T 7/00

(52) U.S. Cl. CPC G06T 7/0012; G06T 2207/30096; G06T 2207/30041; G06T 2207/10048; G06T 2207/10101; G06T 2207/10064

(57) ABSTRACT

A method and system for evaluating geographic atrophy in a retina. A set of fundus autofluorescence (FAF) images of the retina is received at a machine learning system. A set of optical coherence tomography (OCT) images of the retina is received at the machine learning system. A lesion growth rate is predicted, via the machine learning system, for a geographic atrophy lesion in the retina using the set of FAF images and the set of OCT images.

### CROSS-REFERENCE TO RELATED APPLICATIONS

The present application is a continuation of International Application No. PCT/US2021/061606, filed on Dec. 2, 2021, which claims priority to and the benefit of the U.S. Provisional Patent Application No. 63/121,125, filed Dec. 3, 2020, titled “Multimodal Prediction Of Geographic Atrophy Growth Rate,” U.S. Provisional Patent Application No. 63/169,764, filed Apr. 1, 2021, titled “Multimodal Prediction Of Geographic Atrophy Growth Rate,” U.S. Provisional Patent Application No. 63/181,813, filed Apr. 29, 2021, titled “Multimodal Prediction Of Geographic Atrophy Growth Rate,” and U.S. Provisional Patent Application No. 63/218,905, filed Jul. 6, 2021, titled “Multimodal Prediction Of Geographic Atrophy Growth Rate,” which are hereby incorporated by reference in their entireties as if fully set forth below and for all applicable purposes.

### FIELD

This description is generally directed towards evaluating geographic atrophy in a retina. More specifically, this description provides methods and systems for predicting a growth rate for a geographic atrophy lesion using images from multiple modalities such as, for example, fundus autofluorescence (FAF) images and optical coherence tomography (OCT) images.

### INTRODUCTION

Age-related macular degeneration (AMD) is a leading cause of vision loss in patients 50 years or older. Geographic atrophy (GA) is one of two advanced stages of AMD and is characterized by progressive and irreversible loss of choriocapillaries, retinal pigment epithelium (RPE), and photoreceptors. GA progression varies between patients and currently, no Food and Drug Administration (FDA) accepted treatment for preventing or slowing down the progression of GA exists. Therefore, predicting GA progression in individual patients may be important to researching GA and developing an effective treatment. Currently, the diagnosis and monitoring of GA lesion enlargement may be performed using fundus autofluorescence (FAF) images that are obtained by confocal scanning laser ophthalmoscopy (cSLO). This type of imaging technology, which shows topographic mapping of lipofuscin in RIPE, can be used to measure the change in GA lesions over time. Further, FAF images may be used to predict the GA growth rate. However, in at least some cases, FAF images may be unable to predict GA growth rate with the desired level of accuracy.

### SUMMARY

In one or more embodiments, a method is provided for evaluating geographic atrophy in a retina. A set of fundus autofluorescence (FAF) images of the retina is received at a machine learning system. A set of optical coherence tomography (OCT) images of the retina is received at the machine learning system. A lesion growth rate is predicted, via the machine learning system, for a geographic atrophy lesion in the retina using the set of FAF images and the set of OCT images.

In one or more embodiments, a method is provided for evaluating geographic atrophy in a retina. A set of fundus autofluorescence (FAF) images of the retina is received at a machine learning system. A set of infrared (IR) images of the retina is received at the machine learning system. A lesion growth rate is predicted, via the machine learning system, for a geographic atrophy lesion in the retina using the set of FAF images and the set of IR images.

### BRIEF DESCRIPTION OF THE DRAWINGS

For a more complete understanding of the principles disclosed herein, and the advantages thereof, reference is now made to the following descriptions taken in conjunction with the accompanying drawings, in which:

FIG. 1A is a block diagram of a lesion evaluation system 100 in accordance with various embodiments.

FIG. 1B is a schematic diagram of the lesion area analytical system 114, in accordance with various embodiments.

FIG. 1C illustrates an example process flow for predicting a baseline lesion area and/or a lesion growth rate for GA lesion in a retina, in accordance with various embodiments.

FIG. 1D illustrates another example process flow for predicting a baseline lesion area and/or a lesion growth rate for GA lesion in a retina, in accordance with various embodiments.

FIG. 1E illustrates another example process flow for predicting a baseline lesion area and/or a lesion growth rate for GA lesion in a retina, in accordance with various embodiments.

FIG. 1F illustrates another example process flow for predicting a baseline lesion area and/or a lesion growth rate for GA lesion in a retina, in accordance with various embodiments.

FIG. 1G illustrates another example process flow for predicting a baseline lesion area and/or a lesion growth rate for GA lesion in a retina, in accordance with various embodiments.

FIG. 2 is a flowchart of a process for predicting geographic atrophy in accordance with various embodiments.

FIG. 3 is a flowchart of a process for predicting geographic atrophy in accordance with various embodiments.

FIG. 4 is a flowchart of an example method of predicting a lesion growth rate for a geographic atrophy lesion in a retina, in accordance with various embodiments.

FIG. 5 is a flowchart of another example method of predicting a lesion growth rate for a geographic atrophy lesion in a retina, in accordance with various embodiments.

FIG. 6 is a flowchart of another example method of predicting a lesion growth rate for a geographic atrophy lesion in a retina, in accordance with various embodiments.

FIG. 7 illustrates an example neural network that can be used to implement a deep learning neural network in accordance with various embodiments.

FIG. 8A illustrates a single modality multi-task model, in accordance with various embodiments.

FIG. 8B illustrates a multi-modality multi-task model, in accordance with various embodiments.

FIG. 9 illustrates example preprocessing steps for optical coherence tomography (OCT) volumes, in accordance with various embodiments.

FIG. 10 shows forest plots comparing model performance of the 3 models and benchmark model on (A) development dataset and (B) holdout dataset, in accordance with various embodiments.

FIG. 11 shows scatter plots of predicted versus observed GA lesion areas and GA growth rates on the holdout dataset, in accordance with various embodiments.

FIG. 12 shows the residual plots 1200 of predicted versus observed GA lesion areas and GA growth rates on the holdout dataset, in accordance with various embodiments.

FIG. 13 shows plots of GA growth rate prediction based on subgroup residual analysis on the holdout dataset, in accordance with various embodiments.

FIG. 14 shows gradient activation maps (GradAM) of GA lesion area and GA growth rate predictions using FAF only, OCT only and multi-modal multi-task models, in accordance with various embodiments.

FIG. 15 is a block diagram of a computer system in accordance with various embodiments.

It is to be understood that the figures are not necessarily drawn to scale, nor are the objects in the figures necessarily drawn to scale in relationship to one another. The figures are depictions that are intended to bring clarity and understanding to various embodiments of apparatuses, systems, and methods disclosed herein. Wherever possible, the same reference numbers will be used throughout the drawings to refer to the same or like parts. Moreover, it should be appreciated that the drawings are not intended to limit the scope of the present teachings in any way.

### DETAILED DESCRIPTION

### I. Overview

The ability to accurately predict geographic atrophy (GA) progression based on, for example, baseline assessments or longitudinal information, may be useful in many different scenarios. As one example, predictions about GA progression may be used to improve patient stratification in clinical trials where the goal is to slow GA progression, thereby allowing for improved assessment of treatment effects. Additionally, in some cases, predictions about GA progression may be used to understand disease pathogenesis via correlation to genotypic or phenotypic signatures.

A GA lesion can be imaged by various imaging modalities. For example, fundus autofluorescence (FAF) images have been used to quantify the GA lesion area. GA growth rate, which is the change in lesion area over some time period, as measured using FAF images, is widely accepted as an anatomic parameter for GA progression in clinical trials. Further, GA growth rate may be predicted from baseline FAF images. However, in at least some cases, GA growth rates predicted using baseline FAF images may not have the desired level of accuracy.

Thus, the various embodiments described herein provide methods and systems for predicting GA growth rate using images from multiple modalities to improve the accuracy of these predictions. More specifically, images from these multiple modalities may be processed using a machine learning system to generate a predicted GA growth rate. Using images from multiple modalities enhances this prediction. For example, an image of a retina from a first modality may provide more information, greater feature resolution, or both when compared to an image of the retina from a second modality. But the image from the second modality may provide some information not identifiable or readily identifiable using the image from the first modality. Processing the information provided from both types of modalities via a machine learning system (e.g., a neural network system, a deep learning system, etc.) may improve the understanding of this information and its use in predicting GA growth rate.

In one or more embodiments, FAF and optical coherence tomography (OCT) images are used to predict GA growth rate. While FAF images are two-dimensional, OCT images are three-dimensional (3D). Thus, OCT images can provide additional structural information about the retinal anatomy, e.g., a GA lesion, that can provide greater understanding of a patient's GA onset and GA progression. For example, reticular pseudo-drusen (RPD), hyperreflective foci, multilayer thickness reduction, photoreceptor atrophy, and subretinal hyporeflectivity (e.g., wedge-shaped subretinal hyporeflectivity) are attributes identifiable in OCT images that have been linked as possible precursors or biomarkers for disease progression. Thus, this type of OCT-derived information may enable improved GA growth rate prediction.

In general, OCT and FAF imaging fundamentally provide different signals or information. For example, FAF can capture lipofuscin autofluorescence after exposure to blue light. Lipofuscin is observable in retinal pigment epithelium (RPE) cells. Accordingly, FAF images provide one view of RPE cells. On the other hand, OCT captures tissue reflectance to near-infrared light in the form of 3D images. OCT images may provide lesion and structural information unavailable in FAF images, while FAF images may image portions of a retina that are not distinguishable or captured clearly by OCT imaging. As stated herein, the differences in these imaging modalities provides complementary information to better visualize the pathology of GA. Moreover, OCT and FAF are not the only imaging modalities that can be useful with the methods and systems herein, and the discussion herein should not be considered to limit the application of the methods and systems herein to just these two modalities. Not only can IR imaging provide additional value, but other imaging modalities can provide similar additional value in determining GA progression.

In certain cases, FAF images may provide more accurate information as compared to OCT images. For example, in some cases, FAF images may provide a more accurate estimation of baseline lesion area as compared to OCT images. Accordingly, using both FAF and OCT modalities together to predict GA growth rate may be more accurate as compared to using solely the FAF modality or solely the OCT modality. In one or more embodiments, using both FAF and OCT modalities may help ensure that the baseline lesion area from which GA growth rate is predicted is sufficiently accurate to enable an improved GA growth rate prediction. Therefore, in accordance with various embodiments herein, a multi-modal analysis of various image types (e.g., OCT and FAF imaging data) can provide both more accurate reads of GA lesion areas and GA growth rate.

Thus, the methods and systems of the present disclosure enable automated GA growth prediction using a multimodal approach and a machine learning system. This multimodal approach may use both FAF and OCT images. In other embodiments, the either imaging modality may be replaced with or supplemented by a third modality such as, for example, without limitation, the infrared (IR) modality. For example, FAF and IR images may be processed via a machine learning system to generate a predicted GA growth rate. IR images and, in particular, near-infrared (NIR) images, may provide a greater field of view than OCT en-face images. In some cases, IR images and, more particularly, NIR images, in combination with FAF images may provide greater clarity with respect to a GA lesion. This greater resolution and clarity may enable improved identification of a lesion area for the GA lesion and thus, ultimately, improved GA growth rate prediction. In still other embodiments, the FAF modality, OCT modality, and IR modality may be used in combination to predict a GA growth rate, with each of these modalities contributing at least some piece of information or some improvement over at least one of the other modalities.

In various embodiments, the imaging data received can undergo pre-processing to enable focused attention on particular regions of interest in the imaging data. This can be done, for example, by reducing noise and/or artifacts in the imaging data that can impair the ability to properly assess particular regions of interest. Moreover, the imaging data from the various modalities may be combined, or fused, in various ways to ensure effective multi-modal analysis for determination of GA growth rate and lesion area. For example, the data from these various modalities may be fused into an integrated multi-channel input that can undergo a subsequent feature extraction process, which can be used as a basis for the growth rate and lesion area determination. In another example, features can be extracted from each individual imaging modality, after which said extracted features themselves can be fused together for growth rate and lesion area determination.

The application of such multi-modal systems and methods is wide. For example, such systems and methods can be used as a prediction tool for GA growth rate. Such system and methods can be used for GA lesion area determination. Moreover, such system and methods can be very useful in the clinical trial space, wherein the embodiments herein can improve confidence in clinical trial development by informing clinical trial design, implementation, and analysis. In particular, the various embodiments herein can allow for adjustment in trial, patient pre-screening, patient enrichment, patient stratification, and post-hoc data analysis (e.g., after clinical trial completion).

Recognizing and taking into account the importance and utility of a methodology and system that can provide the improvements described above, the specification describes various embodiments for evaluating GA progression using images of multiple modalities (e.g., FAF images and OCT images). More particularly, the specification will describe various embodiments of methods and systems for processing these multimodal images using a machine learning system (e.g., a neural network system) to accurately predict the growth rate corresponding to a GA lesion.

### II. Definitions

The disclosure is not limited to these exemplary embodiments and applications or to the manner in which the exemplary embodiments and applications operate or are described herein. Moreover, the figures may show simplified or partial views, and the dimensions of elements in the figures may be exaggerated or otherwise not in proportion.

In addition, as the terms “on,” “attached to,” “connected to,” “coupled to,” or similar words are used herein, one element (e.g., a component, a material, a layer, a substrate, etc.) can be “on,” “attached to,” “connected to,” or “coupled to” another element regardless of whether the one element is directly on, attached to, connected to, or coupled to the other element or there are one or more intervening elements between the one element and the other element. In addition, where reference is made to a list of elements (e.g., elements a, b, c), such reference is intended to include any one of the listed elements by itself, any combination of less than all of the listed elements, and/or a combination of all of the listed elements. Section divisions in the specification are for ease of review only and do not limit any combination of elements discussed.

The term “subject” may refer to a subject of a clinical trial, a person undergoing treatment, a person undergoing anti-cancer therapies, a person being monitored for remission or recovery, a person undergoing a preventative health analysis (e.g., due to their medical history), or any other person or patient of interest. In various cases, “subject” and “patient” may be used interchangeably herein.

Unless otherwise defined, scientific and technical terms used in connection with the present teachings described herein shall have the meanings that are commonly understood by those of ordinary skill in the art. Further, unless otherwise required by context, singular terms shall include pluralities and plural terms shall include the singular. Generally, nomenclatures utilized in connection with, and techniques of, chemistry, biochemistry, molecular biology, pharmacology and toxicology are described herein are those well-known and commonly used in the art.

As used herein, “substantially” means sufficient to work for the intended purpose. The term “substantially” thus allows for minor, insignificant variations from an absolute or perfect state, dimension, measurement, result, or the like such as would be expected by a person of ordinary skill in the field but that do not appreciably affect overall performance. When used with respect to numerical values or parameters or characteristics that can be expressed as numerical values, “substantially” means within ten percent.

As used herein, the term “about” used with respect to numerical values or parameters or characteristics that can be expressed as numerical values means within ten percent of the numerical values. For example, “about 50” means a value in the range from 45 to 55, inclusive.

The term “ones” means more than one.

As used herein, the term “plurality” can be 2, 3, 4, 5, 6, 7, 8, 9, 10, or more.

As used herein, the term “set of” means one or more. For example, a set of items includes one or more items.

As used herein, the phrase “at least one of,” when used with a list of items, means different combinations of one or more of the listed items may be used and only one of the items in the list may be used. The item may be a particular object, thing, step, operation, process, or category. In other words, “at least one of” means any combination of items or number of items may be used from the list, but not all of the items in the list may be used. For example, without limitation, “at least one of item A, item B, or item C” means item A; item A and item B; item B; item A, item B, and item C; item B and item C; or item A and C. In some cases, “at least one of item A, item B, or item C” means, but is not limited to, two of item A, one of item B, and ten of item C; four of item B and seven of item C; or some other suitable combination.

As used herein, a “model” may include one or more algorithms, one or more mathematical techniques, one or more machine learning algorithms, or a combination thereof.

As used herein, “machine learning” includes the practice of using algorithms to parse data, learn from it, and then make a determination or prediction about something in the world. Machine learning uses algorithms that can learn from data without relying on rules-based programming.

As used herein, an “artificial neural network” or “neural network” (NN) may refer to mathematical algorithms or computational models that mimic an interconnected group of artificial neurons that processes information based on a connectionistic approach to computation. Neural networks, which may also be referred to as neural nets, can employ one or more layers of nonlinear units to predict an output for a received input. Some neural networks include one or more hidden layers in addition to an output layer. The output of each hidden layer may be used as input to the next layer in the network, i.e., the next hidden layer or the output layer. Each layer of the network generates an output from a received input in accordance with current values of a respective set of parameters. In the various embodiments, a reference to a “neural network” may be a reference to one or more neural networks.

A neural network may process information in two ways; when it is being trained it is in training mode and when it puts what it has learned into practice it is in inference (or prediction) mode. Neural networks learn through a feedback process (e.g., backpropagation) which allows the network to adjust the weight factors (modifying its behavior) of the individual nodes in the intermediate hidden layers so that the output matches the outputs of the training data. In other words, a neural network learns by being fed training data (learning examples) and eventually learns how to reach the correct output, even when it is presented with a new range or set of inputs. A neural network may include, for example, without limitation, at least one of a Feedforward Neural Network (FNN), a Recurrent Neural Network (RNN), a Modular Neural Network (MNN), a Convolutional Neural Network (CNN), a Residual Neural Network (ResNet), an Ordinary Differential Equations Neural Networks (neural-ODE), or another type of neural network.

As used herein, a “lesion” may include a region in an organ or tissue that has suffered damage (via injury or disease). This region may be a continuous or discontinuous region. For example, as used herein, a lesion may include multiple regions. A geographic atrophy (GA) lesion is a region of the retina that has suffered chronic progressive degeneration. As used herein, a GA lesion may include one lesion (e.g., one continuous lesion region) or multiple lesions (e.g., discontinuous lesion region comprised of multiple, separate lesions).

As used herein, a “total lesion area” may refer to an area (including a total area) covered by a lesion, whether that lesion be a continuous region or a discontinuous region.

As used herein, “longitudinal” means over a period of time. The period of time may be in days, weeks, months, years, or some other measure of time.

As used herein, a “growth rate” corresponding to a GA lesion may refer to a longitudinal change in the lesion area of the GA lesion and/or a pace of the longitudinal change in the lesion area. This growth rate may also be referred to as a GA growth rate.

As used herein, “fusion” means merging data, clinical data, feature inputs, or inputs. This fusion may also be referred to as “fusing together”, for example, merging two or more sets of data, two or more clinical data (e.g., clinical factor data or clinical trial data), two or more feature inputs, or two or more inputs.

As used herein, “flattening” OCT images means forming a more consistent dataset with minimal distortions characteristics in the OCT images. The flattening may also be referred to as volume flattening or flattening of OCT volume.

### III. Multimodal Prediction of Geographic Atrophy (GA) Growth Rate

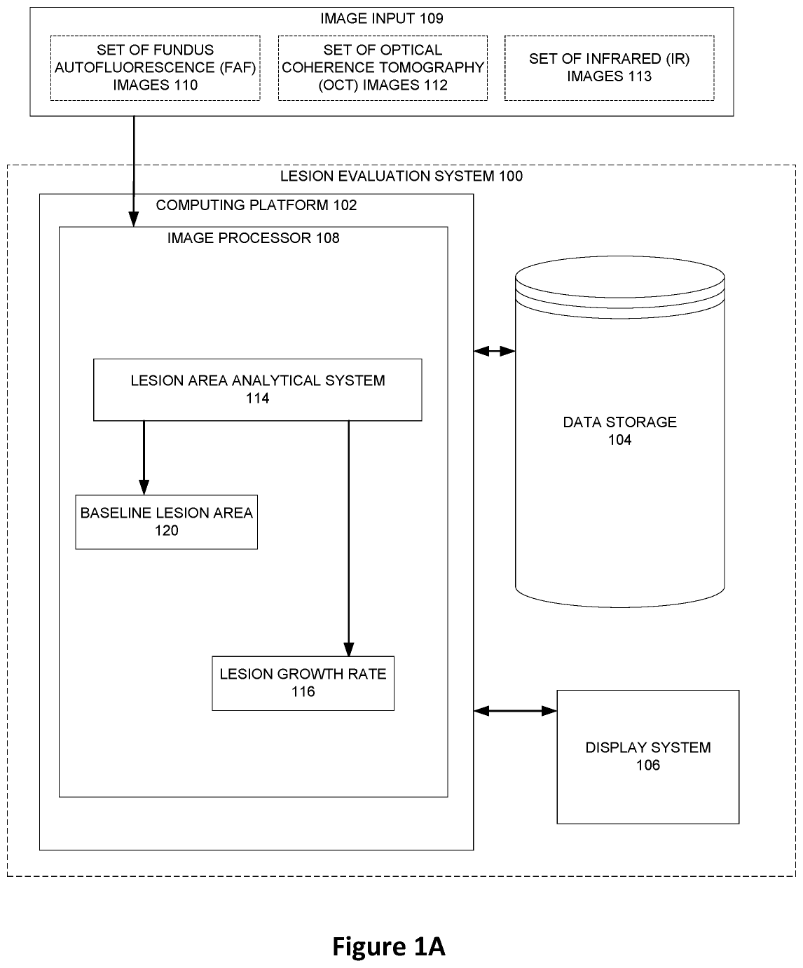

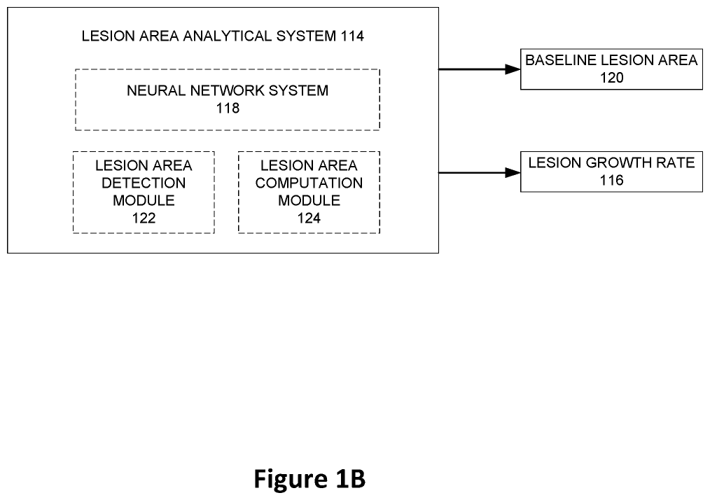

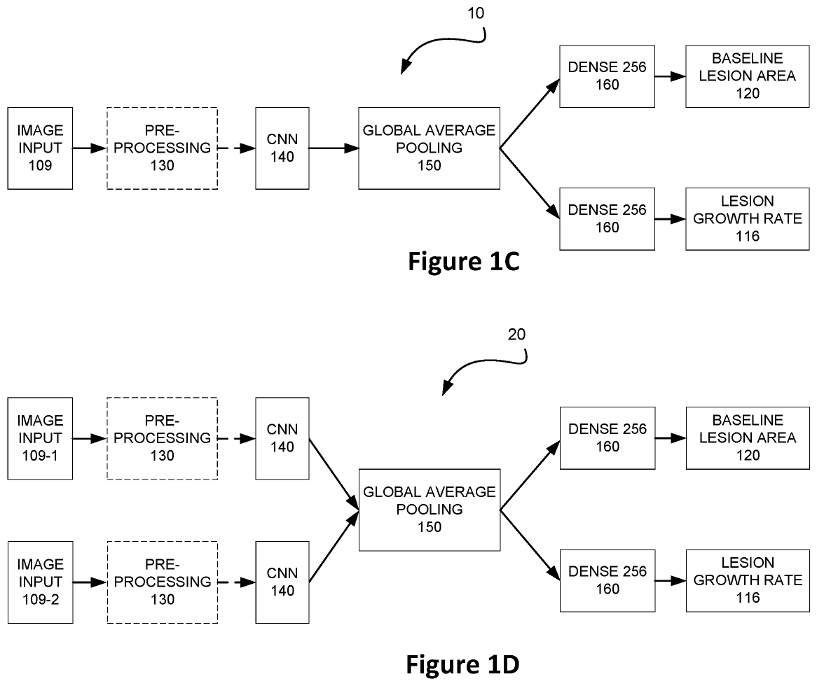

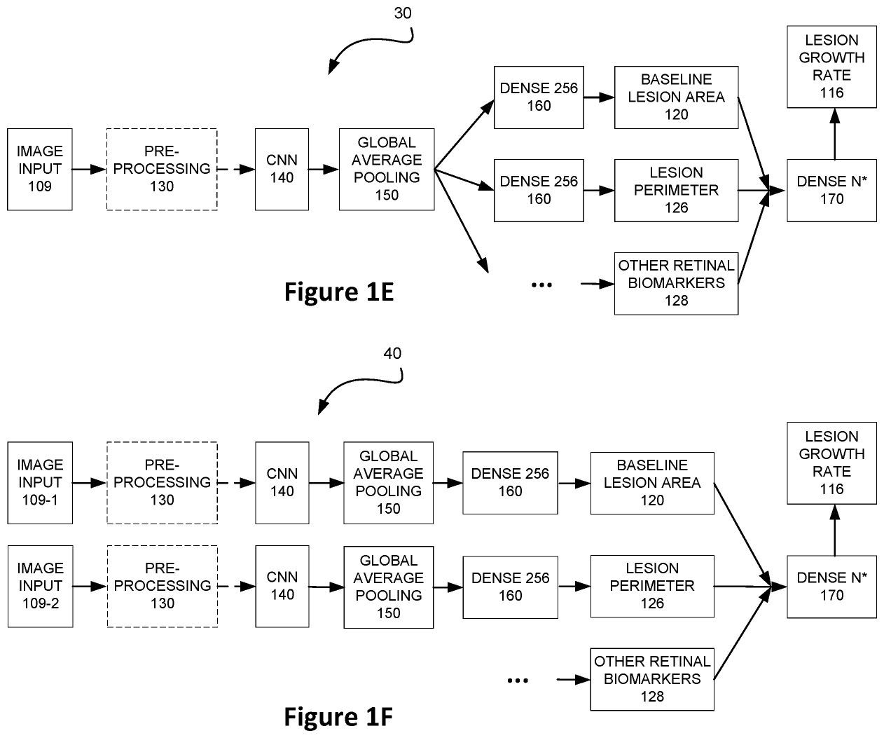

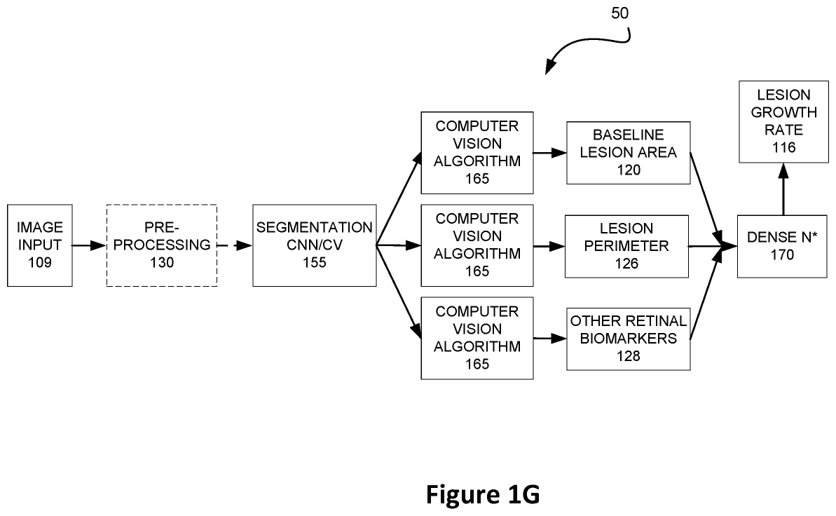

FIG. 1A is a block diagram of a lesion evaluation system 100 in accordance with various embodiments. Lesion evaluation system 100 is used to evaluate geographic atrophy (GA) lesions in the retinas of subjects. Lesion evaluation system 100 includes computing platform 102, data storage 104, and display system 106. Computing platform 102 may take various forms. In one or more embodiments, computing platform 102 includes a single computer (or computer system) or multiple computers in communication with each other. In other examples, computing platform 102 takes the form of a cloud computing platform.

Data storage 104 and display system 106 are each in communication with computing platform 102. In some examples, data storage 104, display system 106, or both may be considered part of or otherwise integrated with computing platform 102. Thus, in some examples, computing platform 102, data storage 104, and display system 106 may be separate components in communication with each other, but in other examples, some combination of these components may be integrated together.

Lesion evaluation system 100 includes image processor 108, which may be implemented using hardware, software, firmware, or a combination thereof. In one or more embodiments, image processor 108 is implemented in computing platform 102.

Image processor 108 receives image input 109 for processing. Image input 109 may include images that are generated at a baseline or reference point in time. In some embodiments, image input 109 may be referred to as baseline image input.

In accordance with various embodiments herein, image input 109 may include any or all of fundus autofluorescence (FAF) imaging data, optical coherence tomography (OCT) imaging data, and/or infrared (IR) imaging data.

In one or more embodiments, fundus autofluorescence (FAF) imaging data may include set of fundus autofluorescence (FAF) images 110 and optical coherence tomography (OCT) imaging data may include set of optical coherence tomography (OCT) images 112. In one or more embodiments, set of FAF images 110 and set of OCT images 112 are unregistered images. However, in other embodiments, set of FAF images 110 and set of OCT images 112 may be registered images.

In some embodiments, image input 109 may include images from other combinations of modalities. For example, in some embodiments, image input 109 may include set of fundus autofluorescence (FAF) images 110 and set of infrared (IR) images 113. In some embodiments, infrared (IR) imaging data may include set of IR images 113, which may be, for example, a set of near-infrared (NIR) images. In one or more embodiments, set of FAF images 110 and set of IR images 113 are unregistered images. However, in other embodiments, set of FAF images 110 and set of IR images 113 may be registered images.

In some embodiments, image input 109 may include images from other combinations of modalities. For example, in some embodiments, image input 109 may include set of OCT images 112 and set of infrared (IR) images 113. Set of IR images 113 may be, for example, a set of near-infrared (NIR) images. In one or more embodiments, set of OCT images 112 and set of IR images 113 are unregistered images. However, in other embodiments, set of OCT images 112 and set of IR images 113 may be registered images.

In still other embodiments, image input 109 may include set of FAF images 110, set of OCT images 112, and set of IR images 113. In one or more embodiments, any or all of set of FAF images 110, set of OCT images 112, and set of IR images 113 are unregistered images. However, in other embodiments, any or all of set of FAF images 110, set of OCT images 112, and set of IR images 113 may be registered images.

Image processor 108 processes image input 109 (e.g., any one, two, or all of set of FAF images 110, set of OCT images 112, and set of IR images 113) using a lesion area analytical system 114 to predict a lesion growth rate 116 corresponding to a GA lesion, as well as determine a lesion area 120. In accordance with various embodiments, lesion area analytical system 114 can predict GA lesion area 120 and GA growth rate 116 simultaneously.

The lesion area analytical system 114 may be implemented in various ways. FIG. 1B illustrates a schematic diagram of the lesion area analytical system 114, in accordance with various embodiments. As illustrated in FIG. 1B, lesion area analytical system 114 may be implemented using a neural network system 118. Neural network system 118 may include any number of or combination of neural networks. In one or more embodiments, neural network system 118 may take the form of a convolutional neural network (CNN) system that includes one or more neural networks. Each of these one or more neural networks may itself be a convolutional neural network. In some instances, neural network system 118 may be a deep learning neural network system. In some cases, neural network system 118 includes multiple subsystems, each including one or more neural networks. As disclosed herein, one or more neural networks of the neural network system 118 may include, for example, without limitation, at least one of a Feedforward Neural Network (FNN), a Recurrent Neural Network (RNN), a Modular Neural Network (MNN), a Convolutional Neural Network (CNN), a Residual Neural Network (ResNet), an Ordinary Differential Equations Neural Networks (neural-ODE), a Squeeze and Excitation embedded neural network, a MobileNet, or another type of neural network.

In various embodiments, lesion area analytical system 114 may include lesion area detection module 122 and lesion area computation module 124. Lesion area analytical system 114, via lesion area detection module 122 and/or lesion area computation module 124, can use FAF images and/or OCT volumes to predict individual GA area and growth rates. Computational module 124, in various embodiments, can utilize a neural network system to predict individual GA area and growth rates. The predictions can be performed via lesion area analytical system 114 using screening images, for example, of image input 109, which may include any or all of FAF images 110, OCT images 112 and IR images 113. In various embodiments, GA growth rate (e.g., mm²/year if annualized) can be derived from a linear model fitted using all available FAF measurements based on accumulated FAF and OCT imaging, which can also be done longitudinally, e.g., every 24 weeks over 2 years.

In accordance with various embodiments, GA growth rate prediction can be formulated as a regression task. For example, using a neural network system 118 having three multi-task convolutional neural networks (CNNs) can be trained with multi-modal imaging data (e.g., a combination of FAF and OCT images) as input to predict (e.g., simultaneously), via lesion area detection module 122 and lesion area computation module 124, the GA lesion area and GA growth rate (e.g., annualized). In various embodiments, a linear model based on baseline GA lesion features, lesion area, lesion distance to fovea, lesion contiguity (unifocal/multifocal), and low luminance deficit (LLD) to derive GA growth rate prediction, can serve as a reference model to benchmark performance.

Resized and normalized FAF/OCT images can be used as input (e.g., fused input) in lesion area analytical system 114. For example, as described in further detail below, FAF images can be resized to 512×512 pixels and normalized between 0 and 1. For OCT volumes (e.g., 3D images), pre-processing can be performed prior to using the images. For example, a histogram matching can be applied first to calibrate differences in image intensity between B-scans, then each B-scan can be flattened along Bruch's membrane (BM). As a non-limiting example, three en-face maps, averaged over full depth, above-BM, and sub-BM depths can be combined as a three-channel input (e.g., fused input). In various embodiments, OCT pre-processing may include general image contrast improvement (or adjustment) with or without volume flattening. The flattening can be along any layers, such as an internal limiting membrane (ILM) of the retina. Alternately or in addition, OCT cross-sectional images can be integrated into image input channels. As further provided below in detail, both above-BM and sub-BM depth can be set at 100 pixels (390 μm), whereas the en-face maps can be resized to 512×512 pixels and normalized between 0 and 1. Setting pixel dimensions and normalized intensity to between 0 and 1 for any two or more sources of imaging data (e.g., any two of the FAF images 110, the OCT images 112, and/or the IR images 113) enable fusing of the aforementioned imaging data prior to feeding them into the lesion area analytical system 114 and/or neural network system 118, or one of both modules of lesion area detection module 122 and lesion area computation module 124.

In addition, in various embodiments, a further data augmentation (can be referred to herein as “offline”) can be performed on the dataset (e.g., three-channel input or fused input). The augmentation may include, for example, but not limited to, horizontal flip, rotation [range, −5 to 5 degrees], and random brightness and contrast [range, −0.2 to 0.2]. After augmentation, the dataset may comprise the original FAF/OCT en-face images and four modified versions of each FAF/OCT en-face image, thus increasing the size of the dataset.

In various embodiments, lesion area analytical system 114 processes image input 109 to predict a lesion growth rate 116 and/or an estimated lesion area 120, which is also referred to herein as GA lesion area, GA area, and baseline lesion area. Rate 116 and lesion area 120 can be determined simultaneously. Lesion area 120 may be a baseline total lesion area for the GA lesion that lesion area analytical system 114 uses to predict lesion growth rate 116. Lesion area analytical system 114 predicts lesion growth rate 116 with a greater accuracy as compared to when a single modality of images is used to evaluate the GA lesion and predict GA progression.

Non-limiting example workflows performed by lesion area analytical system 114, for example, for predicting GA lesion area and/or predicting a lesion growth rate for the GA lesion are described as follows with respect to FIGS. 1C, 1D, 1E, 1F, and 1G.

FIG. 1C illustrates a process flow 10 for predicting a baseline lesion area and/or a lesion growth rate for GA lesion in a retina, in accordance with various embodiments. In various embodiments, process flow 10 is implemented using a system, such as, the lesion evaluation system 100 and performed by lesion area analytical system 114 described with respect to FIG. 1. As illustrated, the process flow 10 begins with receiving image input 109, which may be one or more of, for example, fundus autofluorescence (FAF) imaging data, optical coherence tomography (OCT) imaging data, and/or infrared (IR) imaging data. In various embodiments, image input 109 may include set of FAF images 110, set of OCT images 112, and/or set of IR images 113.

In various embodiments, the set of FAF images 110, set of OCT images 112, and/or set of IR images 113 may be pre-processed, as desired, via pre-processing 130. Pre-processing 130 is an optional process step that can be performed on the image input 109 in process flow 10. Pre-processing 130, for example, for pre-processing FAF images 110, may include one or more methods, including but not limited to, auto macular field FAF image selection, region of interest extraction (for example, auto mask disc area), image contrast improvement (such as histogram equalization), combining multiple FAF images into one multi-channel input, etc. In some embodiments, pre-processing 130 may include resizing FAF imaging data or images to suitable dimensions, or normalizing the FAF imaging data or images between 0 and 1. In some embodiments, pre-processing the FAF imaging data may include macular field FAF image selection, region of interest extraction, image contrast adjustment, or multi-field FAF image combination.

In various embodiments, pre-processing 130, for example, for pre-processing OCT images 112 may include, but not limited to, general image contrast adjustment (or improvement) with or without volume flattening. In various embodiments, the flattening of the OCT images 112 may be performed along any layers, such as the internal limiting membrane (ILM) of the retina. Alternately or in addition, OCT cross-sectional images may be integrated into image input channels. In various embodiments, pre-processing 130 may include flattening the OCT imaging data along the Bruch's membrane, averaging a set of en-face maps over one or more of full, above Bruch's membrane and below Bruch's membrane depths, and combining the set of en-face maps to produce a multi-channel OCT input for predicting the lesion growth rate for the GA lesion. In various embodiments, pre-processing the OCT imaging data may include generating a set of en-face maps above a retinal membrane and below the retinal membrane and predicting the lesion growth rate for the GA lesion using the generated set of en-face maps. In some embodiments, artifacts, such as the corneal curvature, motion of the eye and the positioning of the camera, may be pre-filtered. Flattening the OCT images 112, for example, may make visualization easier by bringing the images into a more consistent shape, which also allows for the efficient truncation of the image input 109. Flattened OCT images may provide for minimal distortion characteristics.

The process flow 10 continues with analysis of the image input 109, with or without pre-processing, using a neural network, such as convolutional neural network (CNN) 140, as illustrated in FIG. 1C. Although CNN 140 is described here for demonstrative purposes, any other suitable neural network systems, such as artificial (ANN) or recurrent (RNN) neural networks, may be used to perform the analysis. In some embodiments, the CNN 140 may include one or more neural networks. Each of these one or more neural networks of the CNN 140 may be a deep learning neural network system. In some cases, CNN 140 may include multiple subsystems, each including one or more neural networks. As disclosed herein, the CNN 140 can be one or more neural networks of the neural network system 118, which includes, for example, without limitation, at least one of a Feedforward Neural Network (FNN), a Recurrent Neural Network (RNN), a Modular Neural Network (MNN), a Residual Neural Network (ResNet), an Ordinary Differential Equations Neural Networks (neural-ODE), a Squeeze and Excitation embedded neural network, a MobileNet, or another type of neural network.

After the analysis via CNN 140, one or more features may be extracted from the analysis and processed via global average pooling (GAP) 150, as illustrated in FIG. 1C. GAP use can allow for image size reduction and computational speed increase, as well as make feature detection more robust. GAP 150 is designed to generate one or more feature maps for desired features, and is particularly useful in the case of multi-class classification, as opposed to binary classification, which GAP can be used for as well. Instead of adding fully connected layers on top of the feature maps, GAP takes the average of each feature map, and the resulting vector is fed forward to, for example, a softmax layer, which can normalize CNN output. One advantage of GAP over the fully connected layers is that it is more native to the convolution structure by enforcing correspondences between feature maps and categories.

In various embodiments, global average pooling 150 is used to fuse or merge features of the image input 109 to form a fused input. In various embodiments, the fused feature input can be formed using a model comprising an average pooling method (as discussed herein), a squeeze and excitation method, or a combination thereof.

In various embodiments, the one or more extracted features (e.g., image features) may be fed into one or more dense-256 layers 160, as illustrated in FIG. 1C. Although dense-256 layer is used as an example, the 256 referring to neuron count on the layer, any other suitable dense layer of given neuron count can be used. Regardless, a dense layer is a hidden layer that generally precedes an output layer of a CNN, and includes a layer of neurons, where each neuron receives input from all neurons from the previous layer in a CNN. In certain cases, the output comes directly from a convolutional layer, in which case the output is multi-dimensional. Therefore, methods such as Flatten( ) can be used to convert multi-dimensional output to single-dimensional input into the dense layer/output layer for image classification.

In various embodiments, lesion area 120 (or baseline lesion area) is predicted via this dense-256 layer 160. In various embodiments, lesion growth rate 116 is predicted via this dense-256 layer 160.

In various embodiments, clinical factor data may be included or generated during global average pooling 150 (e.g., fusing of features) and/or prior to convolutional layer output being fed to dense layer such as dense-256 layer 160. In various embodiments, the clinical factor data may include any clinical features and/or a subject's age, sex, smoking status, an observed GA lesion area, a distance of an observed GA lesion to a foveal center of the retina, image contiguity, a best-corrected visual acuity (BCVA) score, a low-luminance deficit (LLD) score, or a combination thereof. Some of this data such as, for example, age, sex, and smoking status, may be information gathered as part of the provided imaging data set being supplied. Other data, referred to as retinal biomarkers, can be generated via CNN, as discussed above.

FIG. 1D illustrates a process flow 20 for predicting a baseline lesion area and/or a lesion growth rate for GA lesion in a retina, in accordance with various embodiments. In various embodiments, process flow 20 is implemented using a system, such as, the lesion evaluation system 100 and performed by lesion area analytical system 114 described with respect to FIG. 1. As disclosed herein, the process flow 20 is a different process than that of process flow 10 and can be implemented using for predicting a baseline lesion area and/or a lesion growth rate for GA lesion in a retina. However, each of the steps in the process flow 20, such as pre-processing 130, CNN 140, global average pooling 150, and dense-layer 256 can be same or substantially same as those described with respect to FIG. 1C, and thus, will not be described in further detail. As illustrated in FIG. 1D, pre-processing 130 and CNN 140 may or may not be the same for image input 109-1 and 109-2, in accordance with various embodiments.

As illustrated in FIG. 1D, process flow 20 can receive multiple inputs of imaging data (e.g., image input 109-1 and image input 109-2) from fundus autofluorescence (FAF) imaging data, optical coherence tomography (OCT) imaging data, and/or infrared (IR) imaging data. As illustrated, each of the image input 109-1 and image input 109-2 can each undergo respective pre-processing via pre-processing 130, and analyzed via CNN 140, similar to those of process flow 10. Once features are extracted from CNN 140, then the features extracted from each of the image input 109-1 and image input 109-2 can be combined to form a fused input. The fused input of the image input 109-1 and image input 109-2 can be averaged via global average pooling 150 to produce an output that is fed into dense-256 layer 160, as illustrated in FIG. 1D. As illustrated in process flow 20, the output, via dense-256 layer 160, may be a baseline lesion area 120 and/or a lesion growth rate 116, as shown in FIG. 1D. In various embodiments, lesion area 120 and/or a lesion growth rate 116 can be predicted simultaneously.

FIG. 1E illustrates a process flow 30 for predicting a baseline lesion area and/or a lesion growth rate for GA lesion in a retina, in accordance with various embodiments. In various embodiments, process flow 30 is implemented using a system, such as, the lesion evaluation system 100 and performed by lesion area analytical system 114 described with respect to FIG. 1. As disclosed herein, process flow 30 is yet a different process than those of process flow 10 and process flow 20, and can be implemented using for predicting a baseline lesion area and/or a lesion growth rate for GA lesion in a retina. In process flow 30 a single image input 109 may be used to feed CNN 140-extracted features to into global average pooling 150, and a first dense-256 layer 160 may produce a baseline lesion area 120 prediction. A second dense-256 layer 160 may produce a lesion perimeter 126. An additional dense-256 layer 160 may produce other retinal biomarkers 128. Once each of the baseline lesion area 120, a lesion perimeter 126, and any other retinal biomarkers 128 are determined, they can be fed into another dense layer, such as dense-n* 170, to produce a lesion growth rate 116 for a patient or subject's retina. For this final dense layer 170, “n*” can represent the number of predicted biomarkers that is output from one of the dense layers 160.

FIG. 1F illustrates a process flow 40 for predicting a baseline lesion area and/or a lesion growth rate for GA lesion in a retina, in accordance with various embodiments. In various embodiments, process flow 40 is implemented using a system, such as, the lesion evaluation system 100 and performed by lesion area analytical system 114 described with respect to FIG. 1. As disclosed herein, process flow 40 is yet a different process than those of process flow 10, process flow 20, or process flow 30, and can be implemented using for predicting a baseline lesion area and/or a lesion growth rate for GA lesion in a retina. Process flow 40 is similar to process flow 20 in that it can receive multiple inputs of imaging data (i.e., image input 109-1 and image input 109-2) from fundus autofluorescence (FAF) imaging data, optical coherence tomography (OCT) imaging data, and/or infrared (IR) imaging data. As illustrated in FIG. 1F, each of the multiple image inputs 109-1 and 109-2 can be independently processed to generate a feature. For example, image input 109-1 is processed via optional pre-processing 130, CNN 140 may extract features to feed into global average pooling 150 where a first dense-256 layer 160 is used to predict baseline lesion area 120. Similarly, image input 109-2 can be processed via optional pre-processing 130, CNN 140 to extract features to feed into global average pooling 150 where a second dense-256 layer 160 is used to predict a lesion perimeter 126. Similarly, any additional image input 109 can be processed through process flow 40, and via additional dense-256 layer 160 to predict additional/other retinal biomarkers 128. As illustrated in FIG. 1F, pre-processing 130 and CNN 140 may or may not be the same for image input 109-1 and 109-2, or any additional image input 109. Once each of the baseline lesion area 120, a lesion perimeter 126, and any other retinal biomarkers 128 are generated, they can be fed into another dense layer, such as dense-n* 170, to produce a lesion growth rate 116 for a patient or subject's retina.

FIG. 1G illustrates a process flow 50 for predicting a baseline lesion area and/or a lesion growth rate for GA lesion in a retina, in accordance with various embodiments. In various embodiments, process flow 50 is implemented using a system, such as, the lesion evaluation system 100 and performed by lesion area analytical system 114 described with respect to FIG. 1. As illustrated in FIG. 1G, instead of applying CNN 140, process flow 50 can employ segmentation CNN/computer vision (CV) 155 to extract features or feature maps, which can then be input into one or more computer vision algorithms 165 to predict baseline lesion area 120, a lesion perimeter 126, and/or any other retinal biomarkers 128. Similar to process flow 30 and process flow 40, the baseline lesion area 120, the lesion perimeter 126, and any other retinal biomarkers 128 can be fed into another dense layer, such as dense-n* 170, to produce a lesion growth rate 116 for a patient or subject's retina.

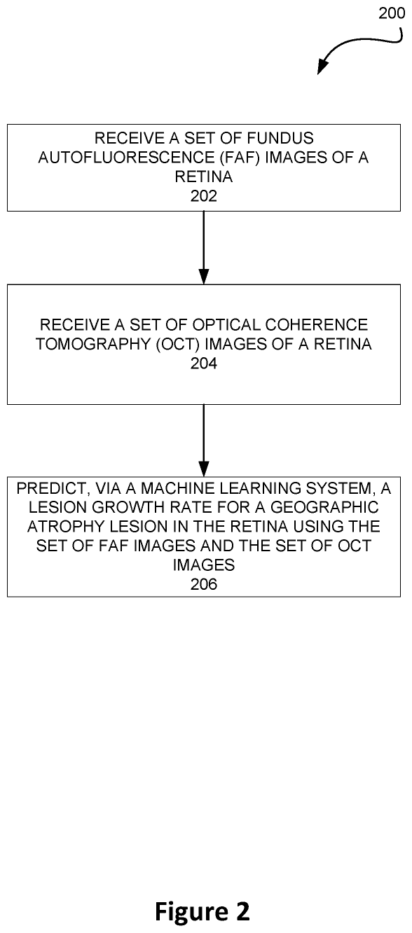

FIG. 2 is a flowchart of a process 200 for evaluating a geographic atrophy lesion in accordance with various embodiments. In various embodiments, process 200 is implemented using the lesion evaluation system 100 described in FIG. 1. In particular, process 200 may be used to predict GA progression.

Step 202 includes receiving a set of fundus autofluorescence (FAF) images of a retina. Step 204 includes receiving a set of optical coherence tomography (OCT) images of the retina. The set of FAF images and the set of OCT images are of the same retina of a subject. Each of the set of FAF images and the set of OCT images may include one or more images. In various embodiments, the set of FAF images and the set of OCT images are baseline images that include corresponding images for the same or substantially same (e.g., within the same hour, within the same day, within the same 1-3 days, etc.) point or points in time.

Step 206 includes predicting, via a machine learning system, a lesion growth rate for a geographic atrophy lesion in the retina using the set of FAF images and the set of OCT images. This predicted lesion growth rate may be more accurate than a growth rate predicted using solely the set of FAF images or solely the set of OCT images. As described above, the set of OCT images may provide greater structural information about the GA lesion because the OCT images are three-dimensional. Further, in some cases, the OCT images may reveal certain features (e.g., precursors or biomarkers of disease progression) that are not as readily identifiable in FAF images.

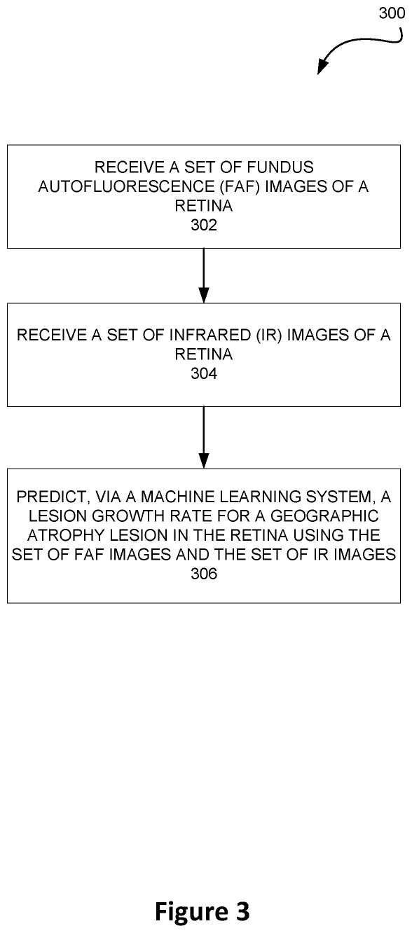

FIG. 3 is a flowchart of a process 300 for evaluating a geographic atrophy lesion in accordance with various embodiments. In various embodiments, process 300 is implemented using the lesion evaluation system 100 described in FIG. 1. In particular, process 300 may be used to predict GA progression.

Step 302 includes receiving a set of fundus autofluorescence (FAF) images of a retina. The retina may belong to a subject that has been diagnosed with geographic atrophy or, in some cases, a precursor stage to geographic atrophy.

Step 304 includes receiving a set of infrared (IR) images of the retina. The set of FAF images and the set of IR images are of the same retina of a subject. Each of the set of FAF images and the set of IR images may include one or more images. In various embodiments, the set of FAF images and the set of IR images are baseline images that include corresponding images for the same or substantially same (e.g., within the same hour, within the same day, within the same 1-3 days, etc.) point or points in time. The set of infrared images may be, for example, a set of near-infrared (NIR) images.

Step 306 includes predicting, via a machine learning system, a lesion growth rate for a geographic atrophy lesion in the retina using the set of FAF images and the set of IR images. This predicted lesion growth rate may be more accurate than a growth rate predicted using solely the set of FAF images or solely the IR images.

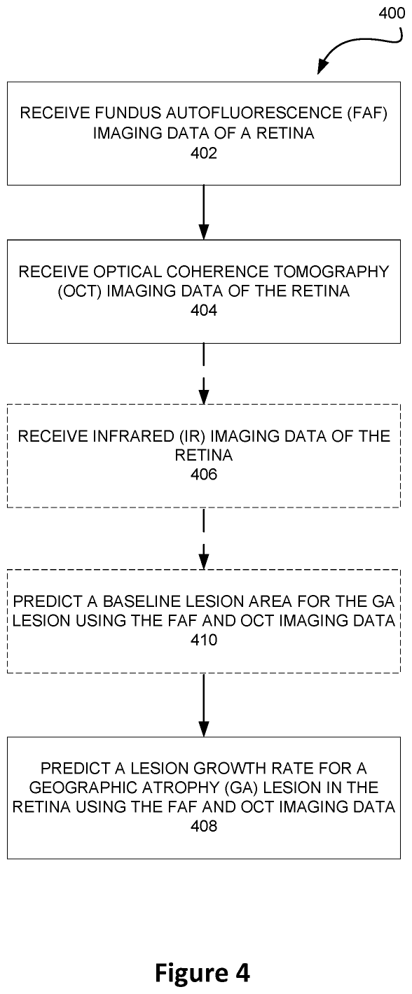

FIG. 4 is a flowchart of a method 400 of predicting a lesion growth rate for a geographic atrophy lesion in a retina, in accordance with various embodiments. In various embodiments, method 400 is implemented using a system, such as, the lesion evaluation system 100 described in FIG. 1. In particular, method 400 may be used to predict lesion growth rate of GA.

As illustrated in FIG. 4, step 402 includes receiving fundus autofluorescence (FAF) imaging data of a retina. The FAF imaging data can be the FAF imaging data of image input 109 of FIG. 1 and can include fundus autofluorescence (FAF) images 110 of FIG. 1. The FAF imaging data may include one or more sets of FAF images. The one or more sets of FAF images maybe unregistered or registered images. The retina may belong to a subject that has been diagnosed with geographic atrophy or, in some cases, a precursor stage to geographic atrophy.

Step 404 includes receiving optical coherence tomography (OCT) imaging data of the retina. The OCT imaging data can be the OCT imaging data of image input 109 of FIG. 1 and can include OCT images 112 of FIG. 1. The OCT imaging data may include one or more sets of OCT images. The one or more sets of OCT images maybe unregistered or registered images.

In some embodiments of the method 400, an optional step 406 may include receiving infrared (IR) imaging data of the retina. The IR imaging data can be the IR imaging data of image input 109 of FIG. 1 and can include IR images 113 of FIG. 1. The IR imaging data may include one or more sets of IR images. The one or more sets of IR images maybe unregistered or registered images.

In various embodiments of the method 400, the one or more sets of FAF images, the one or more sets of OCT images, and/or the optional one or more sets of IR images are of the same retina of a subject. Each of the one or more sets of FAF images, the one or more sets of OCT images, and/or the optional one or more sets of IR images may include one or more images. In various embodiments, the one or more sets of FAF images, the one or more sets of OCT images, and/or the optional one or more sets of IR images are baseline images that include corresponding images for the same or substantially same (e.g., within the same hour, within the same day, within the same 1-3 days, etc.) point or points in time.

Step 410 includes predicting a lesion growth rate for a geographic atrophy lesion in the retina using the FAF imaging data and the OCT imaging data. In some embodiments of the method 400, step 410 may include predicting the lesion growth rate for the geographic atrophy lesion in the retina using the FAF imaging data, the OCT imaging data, and/or the IR imaging data.

In accordance with various embodiments, the predicting is performed via a machine learning system, such as the lesion area analytical system 114 as described with respect to FIG. 1. The predicted lesion growth rate using the FAF imaging data and the OCT imaging data may be more accurate than a growth rate predicted using solely the set of FAF images or solely the set of OCT images. As described above, the set of OCT images may provide greater structural information about the GA lesion because the OCT images are three-dimensional. Further, in some cases, the OCT images may reveal certain features (e.g., precursors or biomarkers of disease progression) that are not as readily identifiable in FAF images.

In some embodiments of the method 400, an optional step 410 may be performed before step 408. The optional step 410 may include predicting a baseline lesion area for the geographic atrophy lesion in the retina using the FAF imaging data and the OCT imaging data. In accordance with various embodiments, the predicting of the baseline lesion area may be performed via a machine learning system, such as the lesion area analytical system 114 as described with respect to FIG. 1. In various embodiments, the machine learning system processes the FAF imaging data and the OCT imaging data to generate an estimated baseline lesion area, which may be a baseline total lesion area for the GA lesion that machine learning system uses to predict the lesion growth rate performed in step 408. In various embodiments, the machine learning system may predict the lesion growth rate with a greater accuracy as compared to when a single modality of images is used to evaluate the GA lesion and predict GA progression.

The machine leaning system used in step 408 and/or optional step 410 may be implemented on using a neural network system, such as the neural network system 118 of FIG. 1. The neural network system used in the predicting of the lesion growth rate for a geographic atrophy lesion may include any number of or combination of neural networks, may take the form of a convolutional neural network (CNN) system that includes one or more neural networks. Each of these one or more neural networks may itself be a convolutional neural network. In some instances, the neural network system may be a deep learning neural network system. In some cases, neural network system includes multiple subsystems, each including one or more neural networks, and may include, for example, without limitation, at least one of a Feedforward Neural Network (FNN), a Recurrent Neural Network (RNN), a Modular Neural Network (MNN), a Convolutional Neural Network (CNN), a Residual Neural Network (ResNet), an Ordinary Differential Equations Neural Networks (neural-ODE), a Squeeze and Excitation embedded neural network, a MobileNet, or another type of neural network.

In various embodiments of the method 400, predicting the lesion growth rate of step 408 can further include generating a first input using the FAF imaging data and a second input using the OCT imaging data, combining the first and second input to form a fused input, and generating the lesion growth rate prediction for the geographic atrophy lesion using the fused input.

In various embodiments, the method 400 may include generating or predicting one or more biomarkers (or retinal biomarkers) from the fused input. In accordance with the various embodiments disclosed herein, the biomarkers may include lesion perimeter, lesion shape-descriptive features, wedge-shaped subretinal hyporeflectivity, retinal pigment epithelium (RPE) attenuation and disruption, hyper-reflective foci, reticular pseudodrusen (RPD), multi-layer thickness reduction, photoreceptor atrophy, hypo-reflective cores in drusen, high central drusen volume, surrounding abnormal autofluorescence patterns, previous GA progression rate, outer-retinal tubulation, choriocapillaris flow void, GA lesion size, GA distance to fovea, lesion contiguity, or a combination thereof. Note that some of these biomarkers may be provided as external inputs based on clinical data provided, for example, as part of the image input.

In various embodiments of the method 400, predicting the lesion growth rate of step 408 may further include generating a first input using the set of FAF images and a second input using the set of OCT images, extracting a first feature of interest from the FAF imaging data, extracting a second feature of interest from the OCT imaging data, fusing together the first feature of interest and the second feature of interest to form a fused feature input, and generating the lesion growth rate for the geographic atrophy lesion using the fused feature input.

In various embodiments, the retina maybe associated with a patient. In such instances, the method 400 may further include receiving clinical factor data associated with the patient, fusing together the clinical factor data with the first feature of interest and the second feature of interest to form the fused feature input, and generating the lesion growth rate for the geographic atrophy lesion using the fused feature input. In some instances, the clinical factor data may include a subject's age, sex, smoking status, an observed GA lesion area, a distance of an observed GA lesion to a foveal center of the retina, image contiguity, a best-corrected visual acuity (BCVA) score, a low-luminance deficit (LLD) score, or a combination thereof.

In various embodiments, the fused feature input can be formed using a model comprising an average pooling method, a squeeze and excitation method, or a combination thereof.

In various embodiments, the method 400 may further include receiving infrared (IR) imaging data of the retina, and predicting, a lesion growth rate for a geographic atrophy lesion in the retina using the FAF imaging data, the OCT imaging data, and the IR imaging data.

In various embodiments, the method 400 may also include pre-processing the FAF imaging data to form the first input. In various embodiments, the pre-processing may include auto macular field FAF image selection, region of interest extraction, image contrast improvement, or multi-field FAF image combination into one multi-channel input, etc. In such instances, the pre-processing may include resizing the FAF imaging data to 512×512 pixels, and normalizing the FAF imaging data between 0 and 1. In various embodiments, the method 400 may also include pre-processing the OCT imaging data to form the second input. In various embodiments, pre-processing OCT images may include, but not limited to, general image contrast improvement, volume flattening from 3D to 2D, etc. In various embodiments, the flattening of the OCT images may be performed along any layers, such as the internal limiting membrane (ILM), wherein OCT cross-sectional images may be integrated into image input channels. In such instances, the pre-processing may include flattening the OCT imaging data along the Bruch's membrane, averaging a set of en-face maps over one or more of full, above Bruch's membrane and below Bruch's membrane depths, and combining the set of en-face maps to produce a multi-channel OCT input for predicting the lesion growth rate for the GA lesion. In some embodiments, the pre-processing may include any pre-processing methods disclosed herein with respect to pre-processing 130 as described within process flows 10, 20, 30, 40, and 50 of FIGS. 1C, 1D, 1E, 1F, and 1G, respectively.

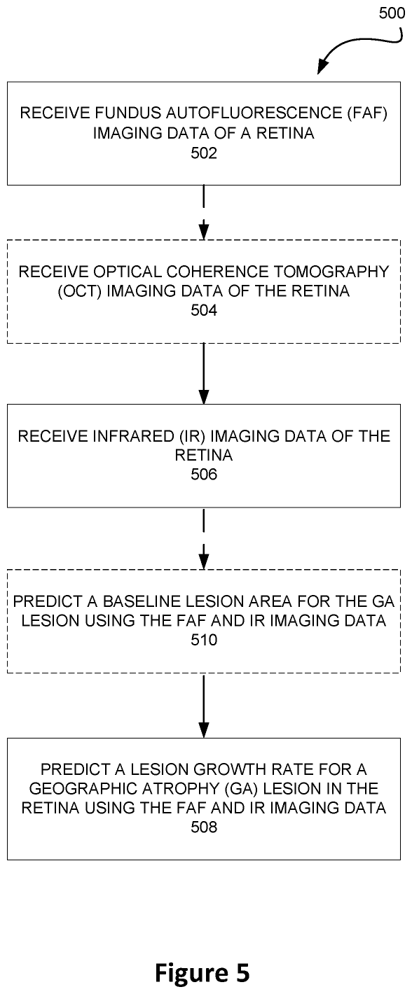

FIG. 5 is a flowchart of a method 500 of predicting a lesion growth rate for a geographic atrophy lesion in a retina, in accordance with various embodiments. In various embodiments, method 500 is implemented using a system, such as, the lesion evaluation system 100 described in FIG. 1. In particular, method 500 may be used to predict lesion growth rate of GA.

As illustrated in FIG. 5, step 502 includes receiving fundus autofluorescence (FAF) imaging data of a retina. The FAF imaging data can be the FAF imaging data of image input 109 of FIG. 1 and can include fundus autofluorescence (FAF) images 110 of FIG. 1. The FAF imaging data may include one or more sets of FAF images. The one or more sets of FAF images maybe unregistered or registered images. The retina may belong to a subject that has been diagnosed with geographic atrophy or, in some cases, a precursor stage to geographic atrophy.

In some embodiments of the method 500, an optional step 504 may include receiving optical coherence tomography (OCT) imaging data of the retina. The OCT imaging data can be the OCT imaging data of image input 109 of FIG. 1 and can include OCT images 112 of FIG. 1. The OCT imaging data may include one or more sets of OCT images. The one or more sets of OCT images maybe unregistered or registered images.

As illustrated in FIG. 5, step 506 includes receiving infrared (IR) imaging data of the retina. The IR imaging data can be the IR imaging data of image input 109 of FIG. 1 and can include IR images 113 of FIG. 1. The IR imaging data may include one or more sets of IR images. The one or more sets of IR images maybe unregistered or registered images.

In various embodiments of the method 500, the one or more sets of FAF images, the one or more sets of IR images, and/or the optional one or more sets of OCT images are of the same retina of a subject. Each of the one or more sets of FAF images, the one or more sets of IR images, and/or the optional one or more sets of OCT images may include one or more images. In various embodiments, the one or more sets of FAF images, the one or more sets of IR images, and/or the optional one or more sets of OCT images are baseline images that include corresponding images for the same or substantially same (e.g., within the same hour, within the same day, within the same 1-3 days, etc.) point or points in time.

Step 510 includes predicting a lesion growth rate for a geographic atrophy lesion in the retina using the FAF imaging data and the IR imaging data. In some embodiments of the method 500, step 510 may include predicting the lesion growth rate for the geographic atrophy lesion in the retina using the FAF imaging data, the IR imaging data, and/or the OCT imaging data.

In accordance with various embodiments, the predicting is performed via a machine learning system, such as the lesion area analytical system 114 as described with respect to FIG. 1. The predicted lesion growth rate using the FAF imaging data and the IR imaging data may be more accurate than a growth rate predicted using solely the set of FAF images or solely the set of IR images. As described above, the set of OCT images may provide greater structural information about the GA lesion because the OCT images are three-dimensional. Further, in some cases, the OCT images may reveal certain features (e.g., precursors or biomarkers of disease progression) that are not as readily identifiable in FAF images.

In some embodiments of the method 500, an optional step 510 may be performed before step 508. The optional step 510 may include predicting a baseline lesion area for the geographic atrophy lesion in the retina using the FAF imaging data and the IR imaging data. In accordance with various embodiments, the predicting of the baseline lesion area may be performed via a machine learning system, such as the lesion area analytical system 114 as described with respect to FIG. 1. In various embodiments, the machine learning system processes the FAF imaging data and the IR imaging data to generate an estimated baseline lesion area, which may be a baseline total lesion area for the GA lesion that machine learning system uses to predict the lesion growth rate performed in step 508. In various embodiments, the machine learning system may predict the lesion growth rate with a greater accuracy as compared to when a single modality of images is used to evaluate the GA lesion and predict GA progression.

The machine leaning system used in step 508 and/or optional step 510 may be implemented on using a neural network system, such as the neural network system 118 of FIG. 1. The neural network system used in the predicting of the lesion growth rate for a geographic atrophy lesion may include any number of or combination of neural networks, may take the form of a convolutional neural network (CNN) system that includes one or more neural networks. Each of these one or more neural networks may itself be a convolutional neural network. In some instances, the neural network system may be a deep learning neural network system. In some cases, neural network system includes multiple subsystems, each including one or more neural networks, and may include, for example, without limitation, at least one of a Feedforward Neural Network (FNN), a Recurrent Neural Network (RNN), a Modular Neural Network (MNN), a Convolutional Neural Network (CNN), a Residual Neural Network (ResNet), an Ordinary Differential Equations Neural Networks (neural-ODE), a Squeeze and Excitation embedded neural network, a MobileNet, or another type of neural network.

In various embodiments of the method 500, predicting the lesion growth rate of step 508 can further include generating a first input using the FAF imaging data and a second input using the IR imaging data, fusing together the first and second input to form a fused input, and generating the lesion growth rate for the geographic atrophy lesion using the fused input.

In various embodiments, the method 500 may include generating or predicting one or more biomarkers (or retinal biomarkers) from the fused input. In accordance with the various embodiments disclosed herein, the biomarkers may include lesion perimeter, lesion shape-descriptive features, wedge-shaped subretinal hyporeflectivity, retinal pigment epithelium (RPE) attenuation and disruption, hyper-reflective foci, reticular pseudodrusen (RPD), multi-layer thickness reduction, photoreceptor atrophy, hypo-reflective cores in drusen, high central drusen volume, surrounding abnormal autofluorescence patterns, previous GA progression rate, outer-retinal tubulation, choriocapillaris flow void, GA lesion size, GA distance to fovea, lesion contiguity, or a combination thereof. Note that some of these biomarkers may be provided as external inputs based on clinical data provided, for example, as part of the image input.

In various embodiments of the method 500, predicting the lesion growth rate of step 508 may further include generating a first input using the set of FAF images and a second input using the set of IR images, extracting a first feature of interest from the FAF imaging data, extracting a second feature of interest from the IR imaging data, fusing together the first feature of interest and the second feature of interest to form a fused feature input, and generating the lesion growth rate for the geographic atrophy lesion using the fused feature input.

In various embodiments, the retina maybe associated with a patient. In such instances, the method 500 may further include receiving clinical factor data associated with the patient, fusing together the clinical factor data with the first feature of interest and the second feature of interest to form the fused feature input, and generating the lesion growth rate for the geographic atrophy lesion using the fused feature input. In some instances, the clinical factor data may include a subject's age, sex, smoking status, an observed GA lesion area, a distance of an observed GA lesion to a foveal center of the retina, image contiguity, a best-corrected visual acuity (BCVA) score, a low-luminance deficit (LLD) score, or a combination thereof.

In various embodiments, the fused feature input can be formed using a model comprising an average pooling method, a squeeze and excitation method, or a combination thereof.

In various embodiments, the method 500 may further include OCT imaging data of the retina, and predicting, a lesion growth rate for a geographic atrophy lesion in the retina using the FAF imaging data, the IR imaging data, and the OCT imaging data.

In various embodiments, the method 500 may also include pre-processing the FAF imaging data to form the first input. In various embodiments, the pre-processing may include auto macular field FAF image selection, region of interest extraction, image contrast improvement, or multi-field FAF image combination into one multi-channel input, etc. In such instances, the pre-processing may include resizing the FAF imaging data to 512×512 pixels, and normalizing the FAF imaging data between 0 and 1. In various embodiments, the method 500 may also include pre-processing the OCT imaging data to form the second input. In various embodiments, pre-processing OCT images may include, but not limited to, general image contrast improvement, volume flattening from 3D to 2D, etc. In various embodiments, the flattening of the OCT images may be performed along any layers, such as the internal limiting membrane (ILM), wherein OCT cross-sectional images may be integrated into image input channels. In various embodiments, the pre-processing may include flattening the OCT imaging data along the Bruch's membrane, averaging a set of en-face maps over one or more of full, above Bruch's membrane and below Bruch's membrane depths, and combining the set of en-face maps to produce a multi-channel OCT input for predicting the lesion growth rate for the GA lesion. In some embodiments, the pre-processing may include any pre-processing methods disclosed herein with respect to pre-processing 130 as described within process flows 10, 20, 30, 40, and 50 of FIGS. 1C, 1D, 1E, 1F, and 1G, respectively.

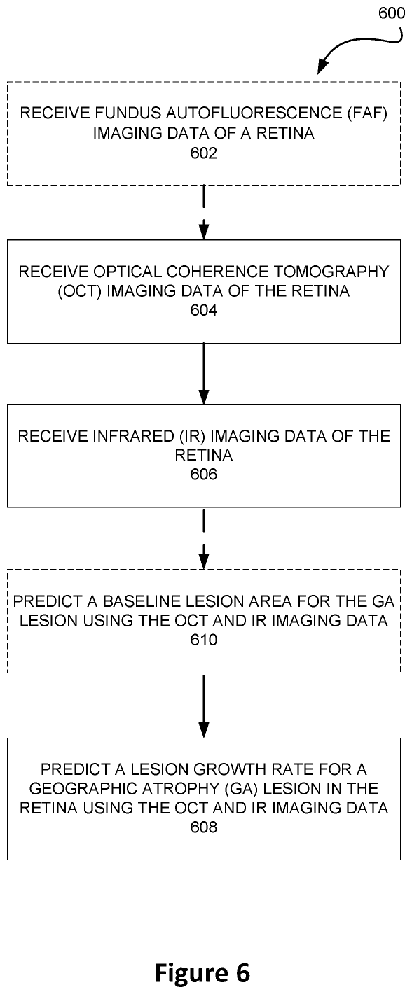

Now referring to FIG. 6, which is a flowchart of a method 600 of predicting a lesion growth rate for a geographic atrophy lesion in a retina, in accordance with various embodiments. In various embodiments, method 600 is implemented using a system, such as, the lesion evaluation system 100 described in FIG. 1. In particular, method 600 may be used to predict lesion growth rate of GA.

As illustrated in FIG. 6, step 604 includes receiving optical coherence tomography (OCT) imaging data of the retina. The retina may belong to a subject that has been diagnosed with geographic atrophy or, in some cases, a precursor stage to geographic atrophy. The OCT imaging data can be the OCT imaging data of image input 109 of FIG. 1 and can include OCT images 112 of FIG. 1. The OCT imaging data may include one or more sets of OCT images. The one or more sets of OCT images maybe unregistered or registered images.

In some embodiments of the method 600, an optional step 602 may include receiving fundus autofluorescence (FAF) imaging data of a retina. The FAF imaging data can be the FAF imaging data of image input 109 of FIG. 1 and can include fundus autofluorescence (FAF) images 110 of FIG. 1. The optional FAF imaging data may include one or more sets of FAF images. The optional one or more sets of FAF images maybe unregistered or registered images.

The method 600 further includes step 606 may include receiving infrared (IR) imaging data of the retina. The IR imaging data can be the IR imaging data of image input 109 of FIG. 1 and can include IR images 113 of FIG. 1. The IR imaging data may include one or more sets of IR images. The one or more sets of IR images maybe unregistered or registered images.

In various embodiments of the method 600, the optional one or more sets of FAF images, the one or more sets of OCT images, and/or the one or more sets of IR images are of the same retina of a subject. Each of the optional one or more sets of FAF images, the one or more sets of OCT images, and/or the one or more sets of IR images may include one or more images. In various embodiments, the optional one or more sets of FAF images, the one or more sets of OCT images, and/or the one or more sets of IR images are baseline images that include corresponding images for the same or substantially same (e.g., within the same hour, within the same day, within the same 1-3 days, etc.) point or points in time.

Step 610 includes predicting a lesion growth rate for a geographic atrophy lesion in the retina using the IR imaging data and the OCT imaging data. In some embodiments of the method 600, step 610 may include predicting the lesion growth rate for the geographic atrophy lesion in the retina using the IR imaging data, the OCT imaging data, and/or the FAF imaging data.

In accordance with various embodiments, the predicting is performed via a machine learning system, such as the lesion area analytical system 114 as described with respect to FIG. 1. The predicted lesion growth rate using the IR imaging data and the OCT imaging data may be more accurate than a growth rate predicted using solely the set of IR images or solely the set of OCT images. As described above, the set of OCT images may provide greater structural information about the GA lesion because the OCT images are three-dimensional. Further, in some cases, the OCT images may reveal certain features (e.g., precursors or biomarkers of disease progression) that are not as readily identifiable in FAF images.

In some embodiments of the method 600, an optional step 610 may be performed before step 608. The optional step 610 may include predicting a baseline lesion area for the geographic atrophy lesion in the retina using the IR imaging data and the OCT imaging data. In accordance with various embodiments, the predicting of the baseline lesion area may be performed via a machine learning system, such as the lesion area analytical system 114 as described with respect to FIG. 1. In various embodiments, the machine learning system processes the IR imaging data and the OCT imaging data to generate an estimated baseline lesion area, which may be a baseline total lesion area for the GA lesion that machine learning system uses to predict the lesion growth rate performed in step 608. In various embodiments, the machine learning system may predict the lesion growth rate with a greater accuracy as compared to when a single modality of images is used to evaluate the GA lesion and predict GA progression.

The machine leaning system used in step 608 and/or optional step 610 may be implemented on using a neural network system, such as the neural network system 118 of FIG. 1. The neural network system used in the predicting of the lesion growth rate for a geographic atrophy lesion may include any number of or combination of neural networks, may take the form of a convolutional neural network (CNN) system that includes one or more neural networks. Each of these one or more neural networks may itself be a convolutional neural network. In some instances, the neural network system may be a deep learning neural network system. In some cases, neural network system includes multiple subsystems, each including one or more neural networks, and may include, for example, without limitation, at least one of a Feedforward Neural Network (FNN), a Recurrent Neural Network (RNN), a Modular Neural Network (MNN), a Convolutional Neural Network (CNN), a Residual Neural Network (ResNet), an Ordinary Differential Equations Neural Networks (neural-ODE), a Squeeze and Excitation embedded neural network, a MobileNet, or another type of neural network.

In various embodiments of the method 600, predicting the lesion growth rate of step 608 can further include generating a first input using the IR imaging data and a second input using the OCT imaging data, fusing together the first and second input to form a fused input, and generating the lesion growth rate for the geographic atrophy lesion using the fused input.

In various embodiments, the method 600 may include generating or predicting one or more biomarkers (or retinal biomarkers) from the fused input. In accordance with the various embodiments disclosed herein, the biomarkers may include lesion perimeter, lesion shape-descriptive features, wedge-shaped subretinal hyporeflectivity, retinal pigment epithelium (RPE) attenuation and disruption, hyper-reflective foci, reticular pseudodrusen (RPD), multi-layer thickness reduction, photoreceptor atrophy, hypo-reflective cores in drusen, high central drusen volume, surrounding abnormal autofluorescence patterns, previous GA progression rate, outer-retinal tubulation, choriocapillaris flow void, GA lesion size, GA distance to fovea, lesion contiguity, or a combination thereof. Note that some of these biomarkers may be provided as external inputs based on clinical data provided, for example, as part of the image input.

In various embodiments of the method 600, predicting the lesion growth rate of step 608 may further include generating a first input using the set of IR images and a second input using the set of OCT images, extracting a first feature of interest from the IR imaging data, extracting a second feature of interest from the OCT imaging data, fusing together the first feature of interest and the second feature of interest to form a fused feature input, and generating the lesion growth rate for the geographic atrophy lesion using the fused feature input.

In various embodiments, the retina maybe associated with a patient. In such instances, the method 600 may further include receiving clinical factor data associated with the patient, fusing together the clinical factor data with the first feature of interest and the second feature of interest to form the fused feature input, and generating the lesion growth rate for the geographic atrophy lesion using the fused feature input. In some instances, the clinical factor data may include a subject's age, sex, smoking status, an observed GA lesion area, a distance of an observed GA lesion to a foveal center of the retina, image contiguity, a best-corrected visual acuity (BCVA) score, a low-luminance deficit (LLD) score, or a combination thereof.

In various embodiments, the fused feature input can be formed using a model comprising an average pooling method, a squeeze and excitation method, or a combination thereof.

In various embodiments, the method 600 may further include FAF imaging data of the retina, and predicting, a lesion growth rate for a geographic atrophy lesion in the retina using the IR imaging data, the OCT imaging data, and the FAF imaging data.

In various embodiments, the method 600 may also include pre-processing the FAF imaging data to form the first input. In various embodiments, the pre-processing may include auto macular field FAF image selection, region of interest extraction, image contrast improvement, or multi-field FAF image combination into one multi-channel input, etc. In such instances, the pre-processing may include resizing the FAF imaging data to 512×512 pixels, and normalizing the FAF imaging data between 0 and 1. In various embodiments, the method 600 may also include pre-processing the OCT imaging data to form the second input. In various embodiments, pre-processing OCT images may include, but not limited to, general image contrast improvement, volume flattening from 3D to 2D, etc. In various embodiments, the flattening of the OCT images may be performed along any layers, such as the internal limiting membrane (ILM), wherein OCT cross-sectional images may be integrated into image input channels. In such instances, the pre-processing may include flattening the OCT imaging data along the Bruch's membrane, averaging a set of en-face maps over one or more of full, above Bruch's membrane and below Bruch's membrane depths, and combining the set of en-face maps to produce a multi-channel OCT input for predicting the lesion growth rate for the GA lesion. In some embodiments, the pre-processing may include any pre-processing methods disclosed herein with respect to pre-processing 130 as described within process flows 10, 20, 30, 40, and 50 of FIGS. 1C, 1D, 1E, 1F, and 1G, respectively.

In various embodiments, a system for implementing the method 400, method 500, and/or method 600 can include a non-transitory memory and a hardware processor coupled with the non-transitory memory and configured to read instructions from the non-transitory memory to cause the system to perform operations of the method 400, method 500, and/or method 600. In various embodiments, the system can be implemented using the lesion evaluation system 100 described in FIG. 1. The operations that the system perform may include receiving fundus autofluorescence (FAF) imaging data of a retina, receiving optical coherence tomography (OCT) imaging data of the retina, and/or receiving infrared (IR) imaging data of the retina, and predicting a lesion growth rate for a geographic atrophy (GA) lesion in the retina using two of the FAF, OCT, and/or IR imaging data (e.g., FAF and OCT imaging data, FAF and IR imaging data, or OCT and IR imaging data).

In various embodiments, a non-transitory computer-readable medium (CRM) may have stored thereon computer-readable instructions executable to cause a computer system to perform operations of the method 400, method 500, and/or method 600. In various embodiments, the operations can be performed or implemented using a system, such as, the lesion evaluation system 100 described in FIG. 1. The CRM may include computer-readable instructions to perform operations that include receiving fundus autofluorescence (FAF) imaging data of a retina, receiving optical coherence tomography (OCT) imaging data of the retina, and/or receiving infrared (IR) imaging data of the retina, and predicting a lesion growth rate for a geographic atrophy (GA) lesion in the retina using two of the FAF, OCT, and/or IR imaging data (e.g., FAF and OCT imaging data, FAF and IR imaging data, or OCT and IR imaging data).

### IV. Artificial Neural Networks

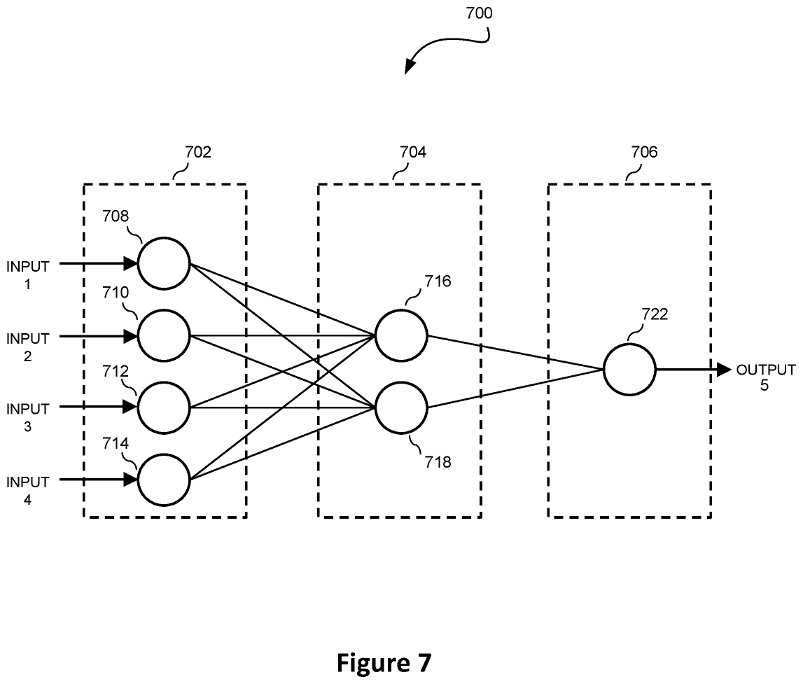

FIG. 7 illustrates an example neural network that can be used to implement a computer-based model according to various embodiments of the present disclosure. For example, the neural network 700 may include the neural network system 118 of the lesion area analytical system 114. As shown, the artificial neural network 700 includes three layers—an input layer 702, a hidden layer 704, and an output layer 706. Each of the layers 702, 704, and 706 may include one or more nodes. For example, the input layer 702 includes nodes 708-714, the hidden layer 704 includes nodes 716-718, and the output layer 706 includes a node 722. In this example, each node in a layer is connected to every node in an adjacent layer. For example, the node 708 in the input layer 702 is connected to both of the nodes 716, 718 in the hidden layer 704. Similarly, the node 716 in the hidden layer is connected to all of the nodes 708-714 in the input layer 702 and the node 722 in the output layer 706. Although only one hidden layer is shown for the artificial neural network 700, it has been contemplated that the artificial neural network 700 used to implement a neural network system, such as the neural network system 118 of the lesion area analytical system 114, may include as many hidden layers as necessary or desired.

In this example, the artificial neural network 700 receives a set of input values (inputs 1-4) and produces an output value (output 5). Each node in the input layer 702 may correspond to a distinct input value. For example, when the artificial neural network 700 is used to implement a neural network system, such as the neural network system 118 of the lesion area analytical system 114, each node in the input layer 702 may correspond to a distinct attribute of the OCT imaging data 110.

In some embodiments, each of the nodes 716-718 in the hidden layer 704 generates a representation, which may include a mathematical computation (or algorithm) that produces a value based on the input values received from the nodes 708-714. The mathematical computation may include assigning different weights to each of the data values received from the nodes 708-714. The nodes 716 and 718 may include different algorithms and/or different weights assigned to the data variables from the nodes 708-714 such that each of the nodes 716-718 may produce a different value based on the same input values received from the nodes 708-714. In some embodiments, the weights that are initially assigned to the features (or input values) for each of the nodes 716-718 may be randomly generated (e.g., using a computer randomizer). The values generated by the nodes 716 and 718 may be used by the node 722 in the output layer 706 to produce an output value for the artificial neural network 700. When the artificial neural network 700 is used to implement a neural network system, such as the neural network system 118 of the lesion area analytical system 114, the output value produced by the artificial neural network 700 may include the baseline lesion area 120 and/or lesion growth rate 116.

The artificial neural network 700 may be trained by using training data. For example, the training data herein may be a set of images from OCT imaging data 112 (see FIG. 1A). By providing training data to the artificial neural network 700, the nodes 716-718 in the hidden layer 704 may be trained (adjusted) such that an optimal output is produced in the output layer 706 based on the training data. By continuously providing different sets of training data, and penalizing the artificial neural network 700 when the output of the artificial neural network 700 is incorrect (e.g., when generating segmentation masks including incorrect GA lesion segments), the artificial neural network 700 (and specifically, the representations of the nodes in the hidden layer 704) may be trained (adjusted) to improve its performance in data classification. Adjusting the artificial neural network 700 may include adjusting the weights associated with each node in the hidden layer 704.

Although the above discussions pertain to an artificial neural network as an example of machine learning, it is understood that other types of machine learning methods may also be suitable to implement the various aspects of the present disclosure. For example, support vector machines (SVMs) may be used to implement machine learning. SVMs are a set of related supervised learning methods used for classification and regression. A SVM training algorithm—which may be a non-probabilistic binary linear classifier—may build a model that predicts whether a new example falls into one category or another. As another example, Bayesian networks may be used to implement machine learning. A Bayesian network is an acyclic probabilistic graphical model that represents a set of random variables and their conditional independence with a directed acyclic graph (DAG). The Bayesian network could present the probabilistic relationship between one variable and another variable. Another example is a machine learning engine that employs a decision tree learning model to conduct the machine learning process. In some instances, decision tree learning models may include classification tree models, as well as regression tree models. In some embodiments, the machine learning engine employs a Gradient Boosting Machine (GBM) model (e.g., XGBoost) as a regression tree model. Other machine learning techniques may be used to implement the machine learning engine, for example via Random Forest or Deep Neural Networks. Other types of machine learning algorithms are not discussed in detail herein for reasons of simplicity and it is understood that the present disclosure is not limited to a particular type of machine learning.

### V. Example Application of the Systems and Methods Disclosed Herein

The following describes example workflows explaining the invention in more detail. The disclosed systems and methods can be used to predict GA area and growth rate using fundus autofluorescence (FAF) images, Infrared (IR) images, and/or spectral-domain optical coherence tomography (OCT) volumes from baseline visits via a multi-modal, multi-task deep learning (DL) approach. Retrospective analysis can be performed using baseline FAF images, IR images, and/or OCT volumes from study eyes of patients with bilateral GA enrolled in the prospective lampalizumab clinical trials. The retrospective analysis of 1722 patients/eyes from prospective lampalizumab clinical trials demonstrate the feasibility of using baseline visit FAF images and/or OCT volumes to predict concurrent GA lesion area and annualized GA growth rate using a multi-task deep learning approach. An accurate prediction of GA growth rate using baseline visit images helps improve clinical trial design, implementation, and analysis.

GA growth rate (mm²/year) was estimated as slope of a linear fit on all the available measurements of lesion area (mm², graded by an independent reading center). The dataset was split into development (1279 patients/eyes) and holdout (443 patients/eyes) sets. Three multi-task convolutional neural network models, FAF-only, OCT-only, and multi-modal (FAF and OCT), were used to simultaneously predict concurrent lesion area and annualized growth rate. Performance was evaluated by calculating the in-sample coefficient of determination (R²) defined as the square of Pearson correlation coefficient (r) between observed and predicted lesion areas/growth rates. Confidence intervals (CI) were calculated by bootstrap resampling (B=10000).

On the development set, performance as mean R² of the FAF-only, OCT-only, and multi-modal models for GA lesion area prediction was 0.93, 0.91 and 0.93, respectively, and for GA growth rate prediction was 0.48, 0.42 and 0.52, respectively. On the holdout dataset, performance as R² (95% CI) of the FAF-only, OCT-only, and multimodal models for GA lesion area prediction was 0.96 (0.95-0.97), 0.91 (0.87-0.95), and 0.94 (0.92-0.96), respectively, and for GA growth rate prediction was 0.48 (0.41-0.55), 0.36 (0.29-0.43), 0.47 (0.40-0.54), respectively.

These findings show the feasibility of using baseline FAF images and/or OCT volumes to predict individual GA area and growth rates utilizing a multi-task DL approach. Artificial intelligence-based predictions using only screening images could potentially inform and improve clinical trial design and patient management.

Geographic atrophy (GA) is an advanced stage of age-related macular degeneration (AMID) and affects approximately 5 million people globally. It is characterized by the progressive loss of photoreceptors, retinal pigment epithelium (RPE), and choriocapillaris, and there is currently no effective approved treatment.

GA lesions can be detected by several modalities including color fundus photography (CFP), fluorescein angiography (FA), fundus autofluorescence (FAF), near-infrared reflectance (NIR), optical coherence tomography (OCT) and optical coherence tomography angiography (OCTA). FAF shows topographic mapping of intrinsic fluorophores within lipofuscin granules in the RPE, and has been used in clinical trials to quantify GA lesion area. The change in FAF-derived GA lesion area over a defined time (i.e., the GA growth rate) has been used as the primary endpoint for GA in clinical trials.

OCT captures cross-sectional, three-dimensional images from tissue microstructures at micrometer resolution and is a standard technique in clinical ophthalmology. As OCT technology has advanced, it is now accepted that OCT images provide structural information that can help characterize GA precursors, onset and progression. OCT imaging is recommended by the Classification of Atrophy Meetings (CAM) group as the reference method for defining different atrophy phenotypes. A number of possible precursors or biomarkers for progression from intermediate to advanced AMD, including conversion to GA, have been observed on OCT images, such as: wedge-shaped subretinal hyporeflectivity, RPE attenuation and disruption, hyper-reflective foci, reticular pseudodrusen (RPD), multi-layer thickness reduction, photoreceptor atrophy, hypo-reflective cores in drusen, and high central drusen volume.

There is typically a large variability in GA growth rate between individuals. Therefore, accurate and personalized GA growth rate prediction could be used to address important clinical and research questions. It could support patient counseling or inform clinical trial design by patient screening, enrichment, and stratification, or clinical trial analysis by prognostic covariate adjustment to increase power. Additionally, it could be used to better understand disease pathogenesis by correlating with genotypic or phenotypic signatures.

Previous studies have attempted to predict GA growth over time using imaging modalities like CFP, FAF, NIR, OCT and OCTA. In general, the GA growth rate has been found to be linear. A recent study on CFP indicated that GA growth rate was strongly correlated to lesion perimeter. Findings from studies on FAF have suggested that lesion shape-descriptive features, surrounding abnormal autofluorescence patterns and previous progression rate were prognostic of GA lesion enlargement. A study using FAF and NIR images showed RPD to be highly predictive of GA lesion growth. A predictive model based on extracted features from OCT volumes demonstrated the ability to predict where GA is likely to grow. Another study on OCT indicated the presence of outer-retinal tubulation may be associated with slower lesion growth. Further, a study on OCTA showed that choriocapillaris flow void could be a precursor to GA lesion growth. Studies have also identified genetic, environmental, and demographic factors associated with development of GA, but their effect on progression of GA is not clear.

Despite the previous findings, the exact mechanisms underlying GA disease progression remain unknown, therefore extracting both image-based and clinical features that accurately predict the individual GA progression remains challenging. However, this presents an opportunity to apply new deep learning techniques for which no prior feature extraction and/or selection is needed. Deep learning algorithms can be used to predict individual GA growth rate from baseline retinal images with promising results. The recurrent neural network-based prediction model can be used to predict where GA is likely to grow.

The study aimed to leverage state-of-the-art deep learning techniques on datasets from previous lampalizumab phase 3 trials and observational studies, to accurately predict GA growth rate. Three multi-task models were trained end-to-end on baseline images: FAF-only, OCT-only and multi-modal (FAF and OCT). Model performance was compared, with each model simultaneously predicting the concurrent GA lesion area and the annualized GA growth rate. A gradient activation heatmap visualization technique was used to determine regions of the image contributing to the model predictions.

This retrospective study used data from study eyes of patients with bilateral GA enrolled in lampalizumab phase 3 clinical trials (Chroma [NCT02247479] and Spectri [NCT02247531]), or in an observational trial (Proxima A [NCT02479386]). The study eye inclusion criteria in these 3 trials were the same and have been previously described. The trials adhered to the Declaration of Helsinki and were Health Insurance Portability and Accountability Act compliant. Protocols were approved by the institutional review board at each site before the trials started. All patients provided written informed consent for future medical research and analyses.

In the current study, macular 30-degree FAF images (768×768 pixels) and macular OCT volumes (496×1024×49 voxels) captured using the Spectralis HRA+OCT (Heidelberg Engineering, Inc., Heidelberg, Germany) were analyzed. The automated real time-function (ART) value indicating the number of images averaged to get a single FAF image or B-scan OCT image was 15 or above. Only study eye images from the baseline visit were used. Since no treatment effect was observed in the phase 3 trials, all treatment arms were pooled for this analysis. GA lesion area from all study visits were graded on FAF images using RegionFinder software (Heidelberg Engineering, Inc., Heidelberg, Germany) in a central reading center by two trained readers with an adjudicator if necessary. GA growth rate (mm²/year) was derived from a linear model fitted using all available FAF measurements for each patient who underwent FAF and OCT imaging every 24 weeks over 2 years. The image dataset was split into development (1279 patients/eyes) and holdout (443 patients/eyes) datasets. The development dataset was further split into 5 folds for nested cross-validation (CV). Baseline characteristics of patients included in the analyses were well-balanced across the dataset splits (Table 1 below). Overall, baseline GA lesion area ranged from 2.54 to 17.78 mm² and GA growth rate ranged from 0.15 to 5.98 mm²/year.

TABLE 1
Baseline characteristics of development and holdout datasets.

| | Development | Holdout |
|---|---|---|
| | data | data |
| | (n = 1279) | (n = 443) |
| Age (years) at parent reference data, | 78.1 (7.97) | 77.0 (8.70) |
| mean (SD) | | |
| Gender, n (%) | | |
| Male | 490 (38.3%) | 188 (42.4%) |
| Female | 789 (61.7%) | 255 (57.6%) |
| Smoking status | | |
| Current | 96 (7.5%) | 19 (4.3%) |
| Never | 639 (50.0%) | 194 (43.8%) |
| Previous | 544 (42.5%) | 230 (51.9%) |
| Study Eye GA area (mm2) by FAF, | 8.10 (4.09) | 8.04 (3.87) |
| mean (SD) | | |
| Study eye lesion location, n (%) | | |
| Subfoveal | 636 (49.7%) | 250 (56.4%) |
| Extrafoveal | 643 (50.3%) | 193 (43.6%) |
| Study eye lesion contiguity, n (%) | | |
| Multifocal | 995 (77.8%) | 348 (78.6%) |
| Non-multifocal | 284 (22.2%) | 95 (21.4%) |
| Study eye BCVA, mean (SD) | 66.0 (9.74) | 66.3 (10.1) |
| ETDRS letters | | |
| Study eye LLD, mean (SD) letters | 30.0 (16.3) | 28.9 (15.9) |

In Table 1, BCVA stands for best-correct visual acuity; ETDRS stands for Early Treatment Diabetic Retinopathy Study; FAF stands for fundus autofluorescence; GA stands for geographic atrophy; LLD stands for low luminance deficit; and SD stands for standard deviation.

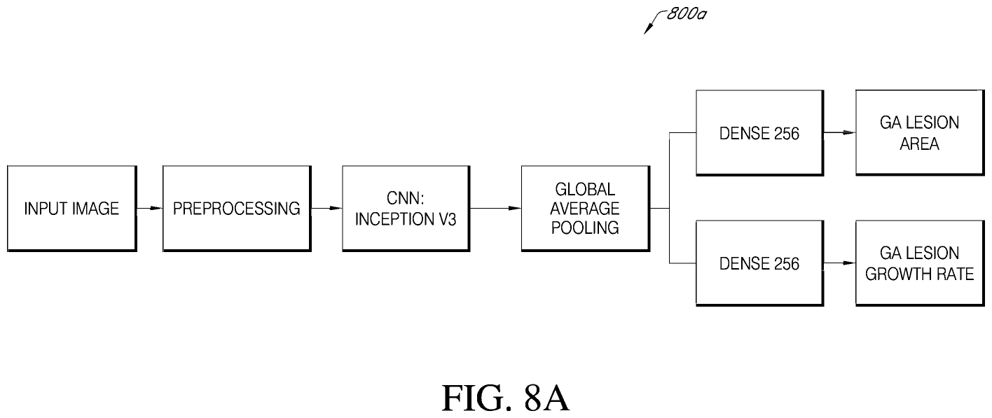

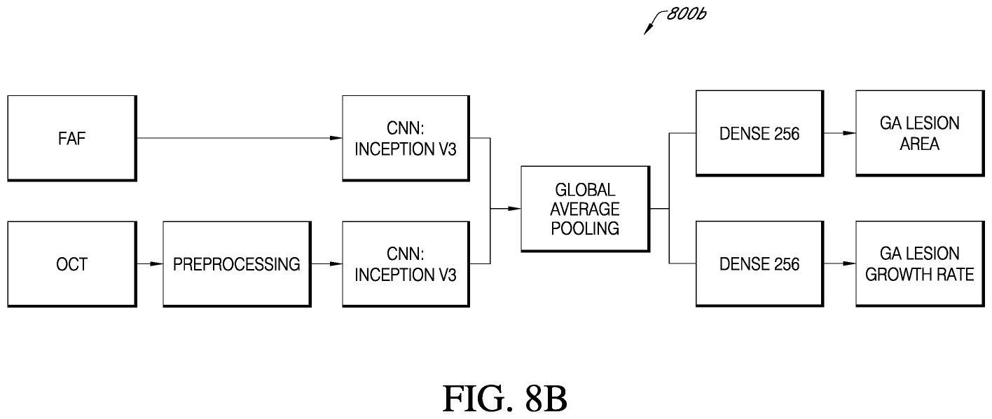

GA growth rate prediction was formulated as a regression task. Three multi-task convolutional neural networks (CNNs) were trained with baseline FAF-only, OCT-only, and multi-modal (a combination of FAF and OCT images) images as input to simultaneously predict the baseline GA lesion area and annualized GA growth rate. A linear model based on baseline GA lesion features, lesion area, lesion distance to fovea, lesion contiguity (unifocal/multifocal), and low luminance deficit (LLD) to derive GA growth rate prediction was used as a reference model to benchmark performance. Baseline visit images provide more prognostic information for GA disease progression than a linear model based on baseline GA lesion features and LLD alone. Furthermore, a multi-modal approach (see FIG. 8B) gives more insight into disease progression and outperform a single modality approach (see FIG. 8A).

Three CNNs were designed to simultaneously predict baseline GA lesion area and annualized GA growth rate. The multi-task model was expected to find a representation capturing the information for both tasks with less chance of over-fitting on the growth rate prediction task alone and possibly improve the performance as the lower feature extracting CNN layers are provided with additional information. The multi-task approach has previously demonstrated good performance. All 3 models used CNN-based deep learning network architecture Inception V3. The network was pre-trained on ImageNet, an image dataset containing 14 million images of 1000 classes before being fully re-trained on the development dataset.

FIGS. 8A and 8B illustrate the overall neural network architectures 800a and 800b. FIG. 8A illustrates a single modality multi-task model, which is the same as process flow 10 illustrated in FIG. 1C, and included here in for comparison purposed to FIG. 8B. FIG. 8B illustrates a multi-modality multi-task model, in accordance with various embodiments. FIG. 8B is substantially similar to process flow 20 described with respect to FIG. 1D, although the neural network architecture 800b is an example where image input 109-1 is FAF imaging data/images and image input 109-2 is OCT imaging data/images. The results shown below is based on FAF imaging data/images without being preprocessed and OCT imaging data/images that have been processed during the analysis.

The model takes resized and normalized baseline FAF/OCT images as input. FAF images were resized to 512×512 pixels and normalized between 0 and 1. For OCT volumes, a histogram matching was applied first to calibrate differences in image intensity between B-scans, then each B-scan was flattened along Bruch's membrane (BM). Three en-face maps, averaged over full depth, above-BM, and sub-BM depths were combined as a three-channel input. Both above-BM and sub-BM depth were 100 pixels (390 μm). The en-face maps were resized to 512×512 pixels and normalized between 0 and 1.

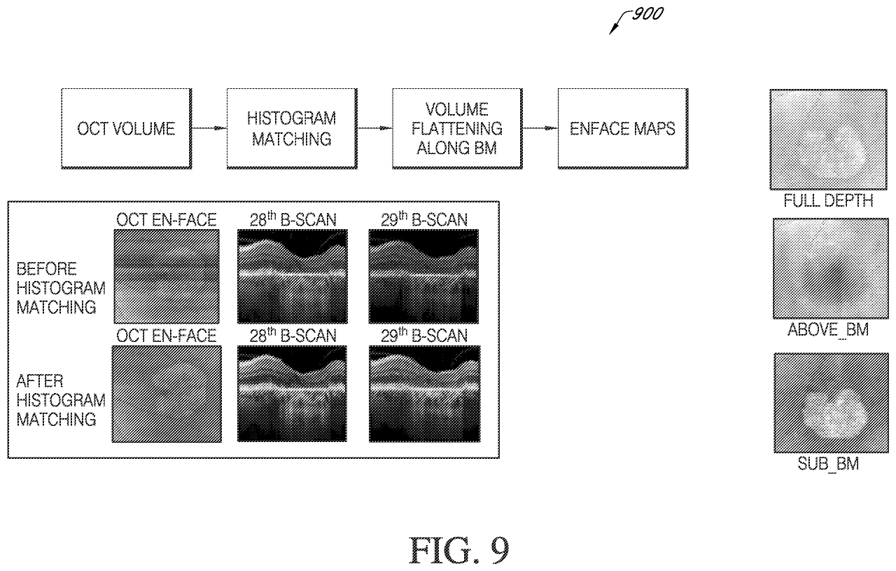

FIG. 9 illustrates example a workflow 900 that includes preprocessing steps for optical coherence tomography (OCT) volumes, in accordance with various embodiments. As illustrated in FIG. 9, the OCT volume can be processed to histogram matching, followed by volume flattening along Bruch's membrane (BM), which is then followed by en-face maps. FIG. 9 also shows scans before and after histogram matching, and an example of en-face maps as a three-channel input. For example, the retinal surfaces obtained from an OCT scanners show different forms of distortions in the B-scan and C-scan slices. These artifacts are thought to be the result of a number of factors such as the corneal curvature, motion of the eye and the positioning of the camera. Flattening the dataset (i.e., flattening the OCT images) makes visualization easier by bringing the dataset into a more consistent shape, which also allows for the efficient truncation of the dataset. Flattened OCT images may have minimal distortions characteristic to optical coherence tomography images.

Offline data augmentation was performed on the development dataset, including horizontal flip, rotation [range, −5 to 5 degrees], and random brightness and contrast [range, −0.2 to 0.2]. After augmentation, the development dataset comprised original FAF/OCT en-face images and 4 modified versions of each FAF/OCT en-face, which increased the size of the development dataset 5-fold. Augmentation was not performed on the holdout dataset.

Performance of each model was evaluated by calculating the in-sample coefficient of determination (R²), defined as the square of the Pearson correlation coefficient (r) between observed and predicted values. The 95% confidence intervals (CI) were derived by bootstrap resampling (B=10000).

In an initial effort to characterize image features that the model may be relying on, the state-of-the-art gradient-weighted class activation mapping method (GradCAM, or GradAM for regression task) was applied to derive heat maps for the 3 modeling approaches on the holdout dataset and reviewed qualitatively.

In the nested CV setting, the tuning of the model hyper-parameters for each outer fold was performed using 5 inner CV folds. At each outer fold level, the best hyper-parameter setting was selected, and the model was re-trained with these hyper-parameters on the inner fold development dataset, and used to predict on the outer fold dataset. For the holdout dataset, 5 models with the best hyper-parameters of each outer fold were re-trained on the development dataset and averaged to get the final prediction on the holdout dataset.

The performance of the 3 multi-task models was first evaluated on the inner folds of development dataset (Table 2).

TABLE 2
Performance of the three multi-task models on the inner folds of the development dataset.

| | GA lesion area prediction (mm²) | | | | | GA growth rate (mm²/year) | | | | |
|---|---|---|---|---|---|---|---|---|---|---|
| | ~Fold 1 | ~Fold 2 | ~Fold 3 | ~Fold 4 | ~Fold 5 | ~Fold 1 | ~Fold 2 | ~Fold 3 | ~Fold 4 | ~Fold 5 |
| Model | (n = | (n = | (n = | (n = | (n = | (n = | (n = | (n = | (n = | (n = |
| type | 1018) | 1028) | 1025) | 1020) | 1025) | 1018) | 1028) | 1025) | 1020) | 1025) |
| FAF only, | 0.92 | 0.94 | 0.92 | 0.91 | 0.92 | 0.43 | 0.46 | 0.45 | 0.48 | 0.45 |
| mean R² | [0.02] | [0.01] | [0.02] | [0.02] | [0.03] | [0.03] | [0.02] | [0.03] | [0.05] | [0.05] |
| (SD) | | | | | | | | | | |
| OCT only, | 0.91 | 0.92 | 0.91 | 0.90 | 0.90 | 0.39 | 0.42 | 0.42 | 0.44 | 0.42 |
| mean R² | [0.03] | [0.01] | [0.03] | [0.02] | [0.02] | [0.05] | [0.05] | [0.05] | [0.03] | [0.05] |
| (SD) | | | | | | | | | | |
| Multi- | 0.92 | 0.93 | 0.92 | 0.92 | 0.93 | 0.48 | 0.48 | 0.48 | 0.52 | 0.51 |
| modal, | [0.03] | [0.01] | [0.02] | [0.02] | [0.04] | [0.05] | [0.04] | [0.03] | [0.03] | [0.03] |
| mean R² | | | | | | | | | | |
| (SD) | | | | | | | | | | |

FAF stands for fundus autofluorescence; GA stands for geographic atrophy; OCT stands for optical coherence tomography; and SD stands for standard deviation.

For the inner CV folds, performance is given as mean R² of 5 randomly split inner folds excluding an outer fold each time.

TABLE 3
Performance of the benchmark model and three multi-task models on the development
dataset and holdout dataset. Development dataset performance is given as mean R² [SD]
and the holdout dataset performance is given as R² [95% CI].

| | GA lesion area prediction (mm²) | | GA growth rate (mm²/year) | |
|---|---|---|---|---|
| | Development | Holdout | Development | Holdout |
| | dataset | dataset | dataset | dataset |
| Model type | (n = 1279) | (n = 443) | (n = 1279) | (n = 443) |
| Benchmark model | N/A | N/A | 0.25 | 0.16 [0.10-0.23] |
| FAF only | 0.93 [0.03] | 0.96 [0.95-0.97] | 0.48 [0.05] | 0.48 [0.41-0.55] |
| OCT only | 0.91 [0.03] | 0.91 [0.87-0.95] | 0.42 [0.04] | 0.36 [0.29-0.43] |
| Multi-modal | 0.93 [0.02] | 0.94 [0.92-0.96] | 0.52 [0.05] | 0.47 [0.40-0.54] |
| (FAF and OCT) | | | | |

Benchmark model is a linear model based on baseline GA lesion area, lesion distance to fovea, lesion contiguity (unifocal/multifocal) and low luminance deficit (LLD). CI stands for confidence interval; FAF stands for fundus autofluorescence; GA stands for geographic atrophy; OCT stands for optical coherence tomography; and SD stands for standard deviation.

Table 3 (above) shows the performance of the benchmark model and the 3 multi-task models in predicting baseline GA lesion area and annualized GA growth rate on the outer folds of the development and holdout datasets. On the development dataset, the multi-modal model had the CV performance with mean R² (standard deviation [SD]) of 0.93 (0.02) and 0.52 (0.05) for GA lesion area and GA growth rate predictions, respectively, compared to the FAF-only [0.93 (0.03) and 0.48 (0.05)] and OCT-only [0.91 (0.03) and 0.42 (0.04)] models (Table 3). On the holdout dataset, R² (bootstrap 95% confidence interval [CI]) values for GA lesion area and GA growth rate were similar for the FAF-only and multi-modal models [0.96 (0.95-0.97) and 0.48 (0.41-0.55) vs. 0.94 (0.92-0.96) and 0.47 (0.40-0.54)], and lower with the OCT-only model [0.91 (0.87-0.95) and 0.36 (0.29-0.43)] (Table 3). In comparison, a previously developed benchmark model using a linear regression model based on baseline visit GA lesion area, lesion distance to fovea, lesion contiguity and LLD showed an R² value of 0.16 (0.10-0.23) for GA growth rate predictions on the same holdout dataset (Table 3).

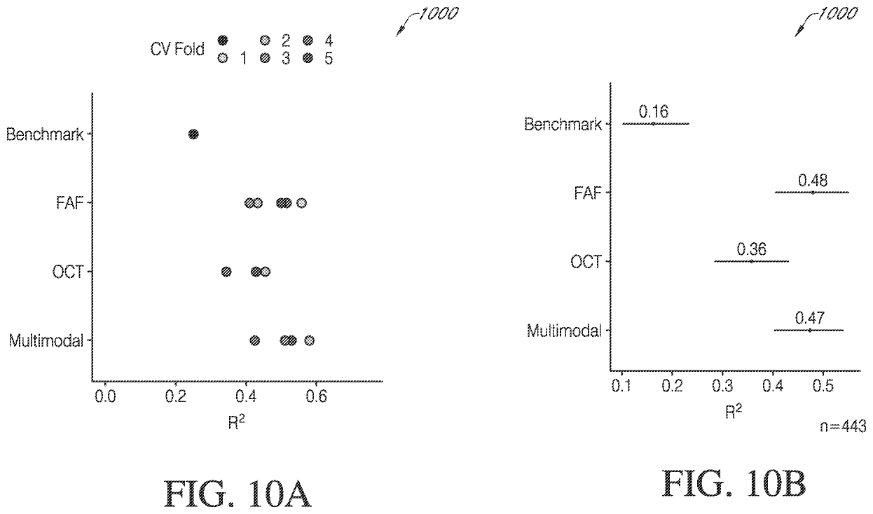

FIG. 10 shows forest plots comparing model performance of the 3 models and benchmark model on (A) development dataset and (B) holdout dataset, in accordance with various embodiments. FIG. 10 shows the corresponding forest plots comparing the benchmark and 3 multi-task models in outer folds of the development and holdout datasets. In the development dataset, the sample size for the clinical benchmark model is 1485 and the sample size for the imaging models is 1279. The 95% CI are derived by B=10000 bootstrap resampling.

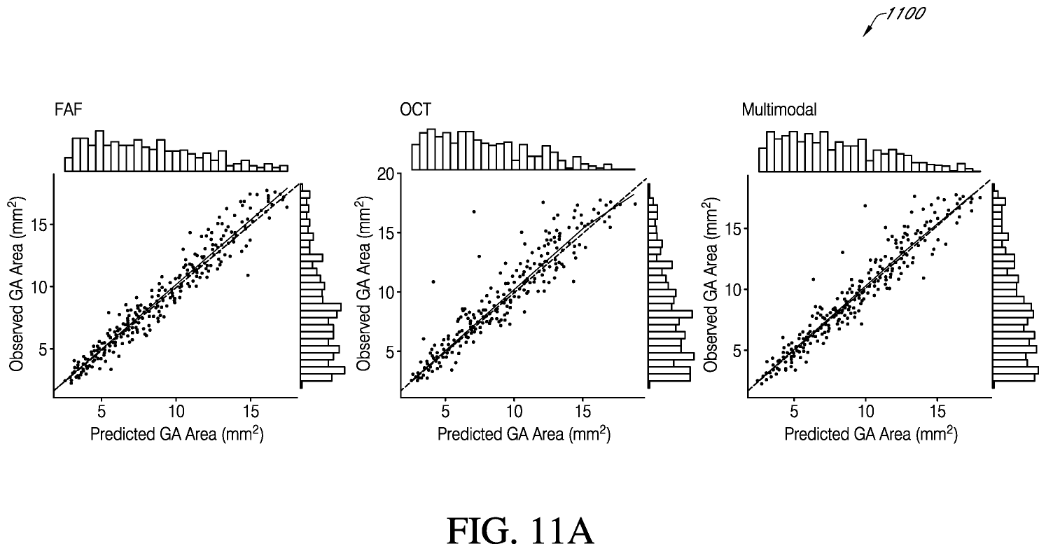

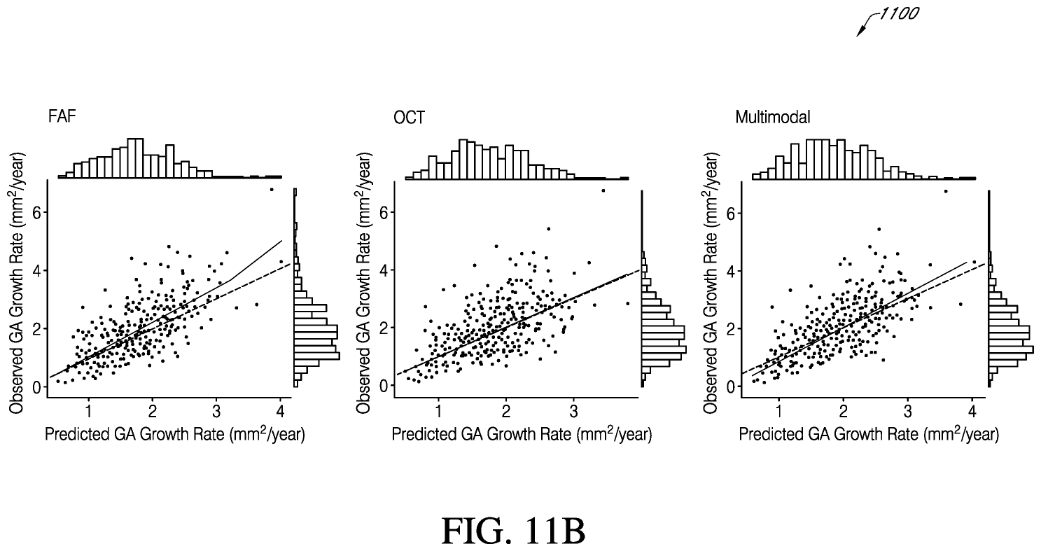

FIG. 11 shows scatter plots 1100 of predicted versus observed GA lesion areas and GA growth rates on the holdout dataset, in accordance with various embodiments. As shown in the plots 1100, scatter plots of (A) predicted GA lesion area versus observed GA lesion area and (B) predicted GA growth rate versus observed GA growth rate of the 3 models on the holdout dataset.

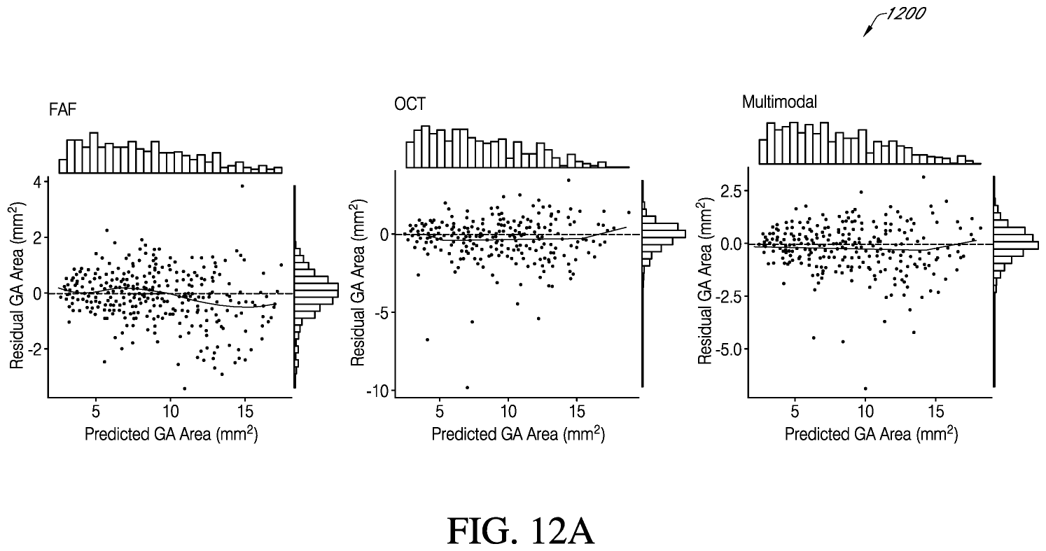

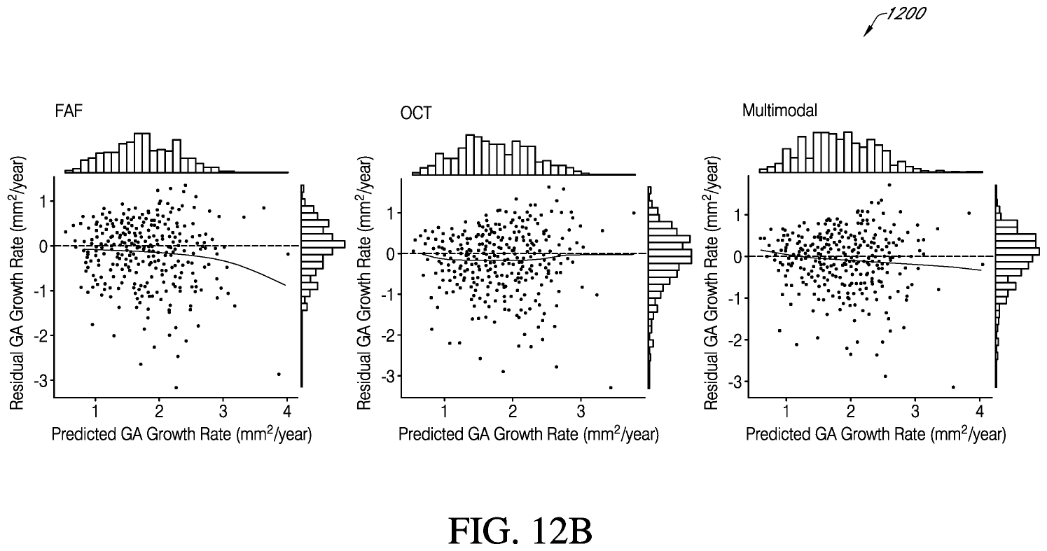

FIG. 12 shows the residual plots 1200 of predicted versus observed GA lesion areas and GA growth rates on the holdout dataset, in accordance with various embodiments. Residual plots of (A) predicted GA lesion area—observed GA lesion area versus observed GA lesion area and (B) predicted GA growth rate—observed GA growth rate versus observed GA growth rate of the 3 models on the holdout dataset are shown.

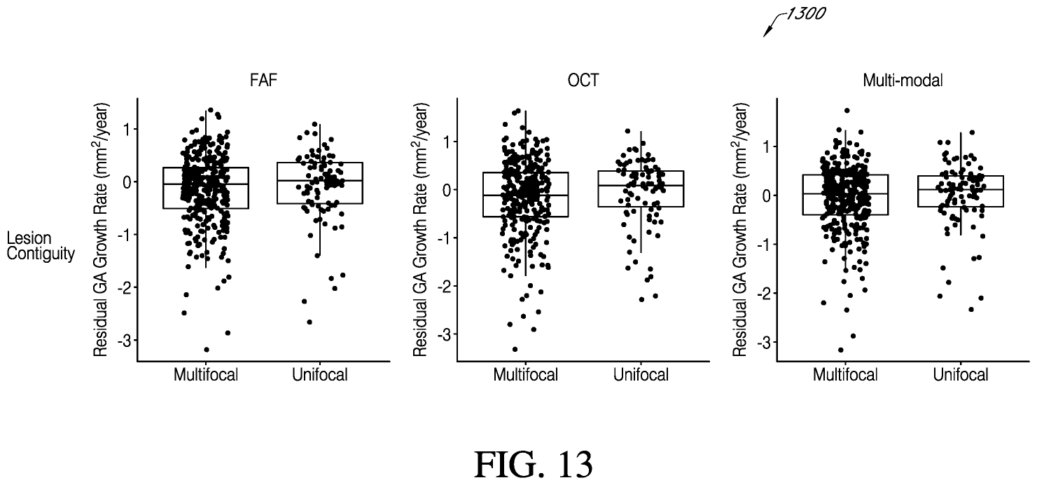

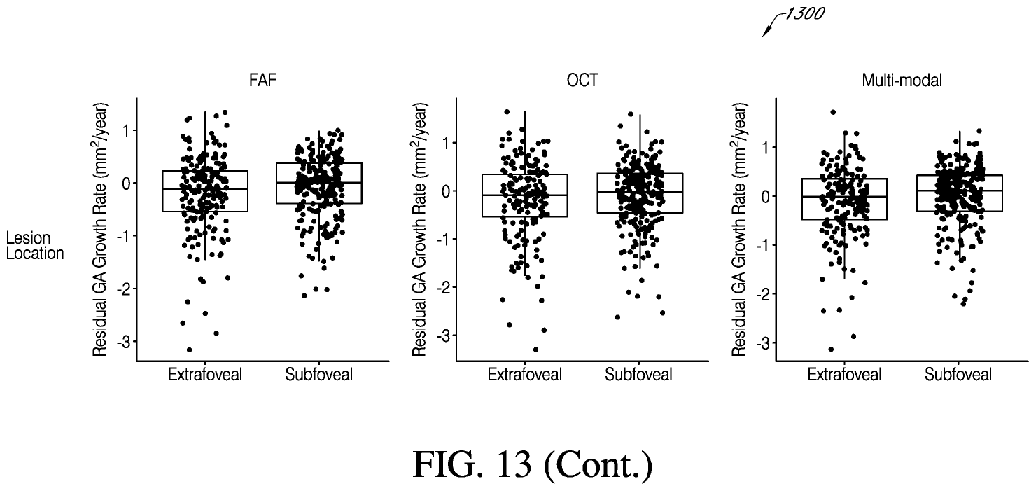

FIG. 13 shows plots 1300 of GA growth rate prediction based on subgroup residual analysis on the holdout dataset, in accordance with various embodiments. Plots 1300 of FIG. 13 show the subgroup analysis performed on the holdout dataset based on subsets of lesion contiguity (unifocal/multifocal) and lesion location (subfoveal/extra-subfoveal). No prediction bias was observed, and all 3 models showed similar performance across both subsets.

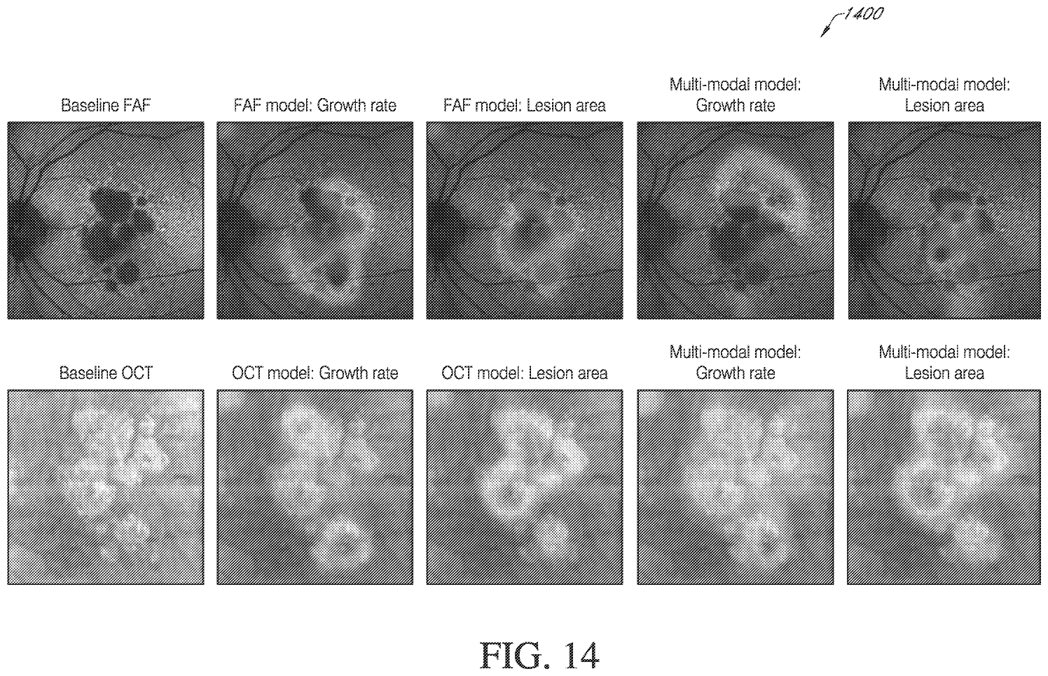

FIG. 14 shows gradient activation maps (GradAM) 1400 of GA lesion area and GA growth rate predictions using FAF only, OCT only and multi-modal multi-task models, in accordance with various embodiments. The GradAM heatmaps 1400 shown in FIG. 14 are of GA lesion area and growth rate predictions for each model. The heatmaps of the GA lesion area predictions highlight the lesion itself, whereas GA growth rate heatmaps highlight the regions around the lesion.

In the nested CV setting, the tuning of the model hyper-parameters for each outer fold was done using 5 inner CV folds. The hyper-parameters tuned were learning rate (0.0001, 0.0002, 0.0005), optimizer (Adam, SGD), loss function (mean squared error, mean absolute error), and dropout (0.1, 0.5, 0.9). The joint loss of mean squared errors or mean absolute errors of GA lesion area prediction and GA growth rate prediction was used for training. The weight for each term was fixed as 0.5. Batch size was also kept constant at 16. Both batch size and loss function weight settings were experimented using 1 inner fold CV data and the optimal settings were then adopted by all folds to reduce the computation cost. The CNN transfer learning model choice was also determined in a similar way; Inception V3 had the best performance compared with VGG16, ResNet50, DenseNet121 and EfficientNets with 1 inner fold CV data. At each outer fold level, after selecting the best hyper-parameter setting, the model was re-trained with these hyper-parameters on the full inner fold development dataset and used to predict on the outer fold dataset. Then for the holdout dataset, 5 models with the individual-fold-best-hyperparameter of each outer fold from nested CV experiments of a model type were re-trained on the entire development dataset. The results from these 5 models were averaged to get the final prediction on the holdout data test. All 3 approaches, FAF-only, OCT-only and multi-modal, went through the same above nested CV and holdout processes. For holdout data, a 95% confidence interval (CI) was calculated by bootstrap resampling, where predictions of each model type on the holdout dataset were resampled 10,000 times and R² was calculated for each sample. The range of the R² of these samples gave an estimate of the CI.

The backend used for designing the CNN and loading pretrained weights was Keras 2.2.4 (2018; Google, Mountain View, California) with Tensorflow 1.8.0 (2018; Google). Programs were run in Python 3.6.3 on an on-premises internal high-processing computing.

This study demonstrated the feasibility of using standardized baseline visit FAF and/or OCT images to predict individual concurrent GA lesion area and annualized GA growth rate with a multi-task deep learning approach. The FAF-only model demonstrated consistently good performance in the development and holdout datasets. The multi-modal approach showed a slight performance improvement in the development datasets, but not in the holdout dataset.

All 3 deep learning models developed in this study had significantly better performance than the reference model using baseline clinical features, suggesting that both FAF and OCT carry additional prognostic information beyond anatomic features quantified as GA lesion size, GA distance to fovea, and lesion contiguity. This finding is consistent with data from other studies: shape-descriptive factors derived from GA lesions in FAF images had prognostic value for GA progression in one study, and several other studies have quantified autofluorescence patterns surrounding the GA lesion that were strongly associated with GA progression rate. OCT image features, such as outer nuclear layer thinning, were also putatively associated with GA progression.

One unique design element of the CNN model architecture used here was its ability to predict GA lesion area and GA growth rate simultaneously. This was based on the prior knowledge that GA lesion area at baseline is associated with GA progression over time. The multi-task model is able to find a representation that captures the information for both tasks at the shared CNN layers. In this way, the model was uniquely guided to look at the clinically relevant regions of the image at the initial feature extracting stage, and therefore it is not entirely a “black-box” compared to directly predicting GA growth rate alone. In addition, there is no consensus or simple mathematical model on the relationship between GA area and growth rate yet. For example, one study found that GA area grew quadratically up to approximately 12 mm² after which growth rate stabilized or decreased. In contrast, another study determining the relationship between GA area at baseline and its progression over time using the square root transformation found that the correlation was negative, suggesting that larger lesions were likely to grow more slowly. The disclosed multi-task CNN model provides a unique non-linear capability in connecting lesion area with progression. Lastly, the multi-task model has less chance of overfitting and potentially demonstrates improved performance. The performance of GA lesion area prediction by all three models was very good, with R² above 0.90 for both nested CV and holdout test results. Potentially, such models could be used in clinical trials for efficient prescreen during patient recruitment, or in clinical practice for patient counselling.

GradCAM is one of the known post-hoc attribution techniques for deep learning models and may provide insight into the image regions that contribute most to the predictions. Here, a variation of GradCAM more suitable for regression tasks was used: GradAM. Interestingly, GradAM heatmaps revealed that the CNN network looked at the lesion itself for making GA lesion area predictions and the regions surrounding the lesion for the GA growth rate predictions, which are consistent with other findings.

This study leveraged the large and well-characterized lampalizumab clinical trial data, which includes patients with bilateral GA and a wide range of clinical presentations. The individual GA growth rate performance using FAF and/or OCT images evaluated by R² value is the best reported to date in the literature, even with models using historical multiple visits. However, the model development, validation and testing were entirely performed on the lampalizumab dataset only. Any use case outside of the population distribution in the lampalizumab trial data needs further assessment. The FAF and OCT images included in this study were captured using the same vendor's devices (Heidelberg Engineering, Inc., Germany), had similar ART values and were of high quality as required for eligibility screening by a central reading center. In various embodiments, more interpretive CNN models or additional explainability techniques can be used to gain insights on the decision-making process, which would help further understand the pathophysiology of GA lesion enlargement and possibly identify new imaging biomarkers. For example, lesion shape features as well as other image extracted features can be explicitly incorporated into statistical models for GA growth rate prediction to increase interpretability and ease of implementation in clinical trial analysis. In addition, images from other modalities (e.g., OCTA, scotopic microperimetric sensitivity) may provide additional predictive value and can be added into the input data for model training as well.

In summary, the feasibility of utilizing baseline FAF and/or OCT images to predict individual GA lesion area and growth rates using a multi-task deep learning approach is demonstrated. In the holdout dataset, the performance of the multi-modal approach was comparable to the simpler FAF-only model. This work could improve confidence in clinical development by informing clinical trial design, implementation, and analysis, specifically prognostic covariate adjustment, patient prescreening, enrichment, and stratification, and/or post hoc data analysis. This technology could also be considered for clinical practice, potentially supporting patient counseling in the future. Further validation in additional datasets may confirm robust performance and any potential benefits of the multi-modal approach over the FAF-only model.

### VI. Computer Implemented System

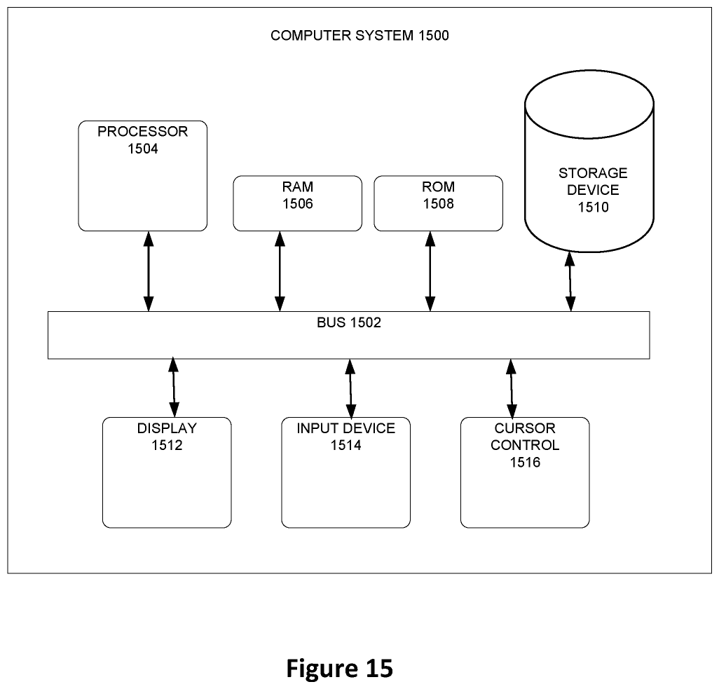

FIG. 15 is a block diagram of a computer system in accordance with various embodiments. Computer system 1500 may be an example of one implementation for computing platform 102 described above in FIG. 1. In one or more examples, computer system 1500 can include a bus 1502 or other communication mechanism for communicating information, and a processor 1504 coupled with bus 1502 for processing information. In various embodiments, computer system 1500 can also include a memory, which can be a random-access memory (RAM) 1506 or other dynamic storage device, coupled to bus 1502 for determining instructions to be executed by processor 1504. Memory also can be used for storing temporary variables or other intermediate information during execution of instructions to be executed by processor 1504. In various embodiments, computer system 1500 can further include a read only memory (ROM) 1508 or other static storage device coupled to bus 1502 for storing static information and instructions for processor 1504. A storage device 1510, such as a magnetic disk or optical disk, can be provided and coupled to bus 1502 for storing information and instructions.

In various embodiments, computer system 1500 can be coupled via bus 1502 to a display 1512, such as a cathode ray tube (CRT) or liquid crystal display (LCD), for displaying information to a computer user. An input device 1514, including alphanumeric and other keys, can be coupled to bus 1502 for communicating information and command selections to processor 1504. Another type of user input device is a cursor control 1516, such as a mouse, a joystick, a trackball, a gesture input device, a gaze-based input device, or cursor direction keys for communicating direction information and command selections to processor 1504 and for controlling cursor movement on display 1512. This input device 1514 typically has two degrees of freedom in two axes, a first axis (e.g., x) and a second axis (e.g., y), that allows the device to specify positions in a plane. However, it should be understood that input devices 1514 allowing for three-dimensional (e.g., x, y and z) cursor movement are also contemplated herein.

Consistent with certain implementations of the present teachings, results can be provided by computer system 1500 in response to processor 1504 executing one or more sequences of one or more instructions contained in RAM 1506. Such instructions can be read into RAM 1506 from another computer-readable medium or computer-readable storage medium, such as storage device 1510. Execution of the sequences of instructions contained in RAM 1506 can cause processor 1504 to perform the processes described herein. Alternatively, hard-wired circuitry can be used in place of or in combination with software instructions to implement the present teachings. Thus, implementations of the present teachings are not limited to any specific combination of hardware circuitry and software.

The term “computer-readable medium” (e.g., data store, data storage, storage device, data storage device, etc.) or “computer-readable storage medium” as used herein refers to any media that participates in providing instructions to processor 1504 for execution. Such a medium can take many forms, including but not limited to, non-volatile media, volatile media, and transmission media. Examples of non-volatile media can include, but are not limited to, optical, solid state, magnetic disks, such as storage device 1510. Examples of volatile media can include, but are not limited to, dynamic memory, such as RAM 1506. Examples of transmission media can include, but are not limited to, coaxial cables, copper wire, and fiber optics, including the wires that comprise bus 1502.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, PROM, and EPROM, a FLASH-EPROM, any other memory chip or cartridge, or any other tangible medium from which a computer can read.

In addition to computer readable medium, instructions or data can be provided as signals on transmission media included in a communications apparatus or system to provide sequences of one or more instructions to processor 1504 of computer system 1500 for execution. For example, a communication apparatus may include a transceiver having signals indicative of instructions and data. The instructions and data are configured to cause one or more processors to implement the functions outlined in the disclosure herein. Representative examples of data communications transmission connections can include, but are not limited to, telephone modem connections, wide area networks (WAN), local area networks (LAN), infrared data connections, NFC connections, optical communications connections, etc.

It should be appreciated that the methodologies described herein, flow charts, diagrams, and accompanying disclosure can be implemented using computer system 1500 as a standalone device or on a distributed network of shared computer processing resources such as a cloud computing network.

The methodologies described herein may be implemented by various means depending upon the application. For example, these methodologies may be implemented in hardware, firmware, software, or any combination thereof. For a hardware implementation, the processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

In various embodiments, the methods of the present teachings may be implemented as firmware and/or a software program and applications written in conventional programming languages such as C, C++, Python, etc. If implemented as firmware and/or software, the embodiments described herein can be implemented on a non-transitory computer-readable medium in which a program is stored for causing a computer to perform the methods described above. It should be understood that the various engines described herein can be provided on a computer system, such as computer system 1500, whereby processor 1504 would execute the analyses and determinations provided by these engines, subject to instructions provided by any one of, or a combination of, the memory components RAM 1506, ROM, 1508, or storage device 1510 and user input provided via input device 1514.

### VII. Conclusion

While the present teachings are described in conjunction with various embodiments, it is not intended that the present teachings be limited to such embodiments. On the contrary, the present teachings encompass various alternatives, modifications, and equivalents, as will be appreciated by those of skill in the art.

For example, the flowcharts and block diagrams described above illustrate the architecture, functionality, and/or operation of possible implementations of various method and system embodiments. Each block in the flowcharts or block diagrams may represent a module, a segment, a function, a portion of an operation or step, or a combination thereof. In some alternative implementations of an embodiment, the function or functions noted in the blocks may occur out of the order noted in the figures. For example, in some cases, two blocks shown in succession may be executed substantially concurrently. In other cases, the blocks may be performed in the reverse order. Further, in some cases, one or more blocks may be added to replace or supplement one or more other blocks in a flowchart or block diagram.

Thus, in describing the various embodiments, the specification may have presented a method and/or process as a particular sequence of steps. However, to the extent that the method or process does not rely on the particular order of steps set forth herein, the method or process should not be limited to the particular sequence of steps described, and one skilled in the art can readily appreciate that the sequences may be varied and still remain within the spirit and scope of the various embodiments.

### VIII. Recitation of Embodiments

Embodiment 1: A method comprising: receiving fundus autofluorescence (FAF) imaging data of a retina; receiving optical coherence tomography (OCT) imaging data of the retina; and predicting a lesion growth rate for a geographic atrophy (GA) lesion in the retina using the FAF and OCT imaging data.

Embodiment 2: The method of Embodiment 1, further comprising: predicting a baseline lesion area for the GA lesion using the FAF and OCT imaging data.

Embodiment 3: The method of Embodiments 1 or 2, predicting the lesion growth rate further comprises: generating a first input using the FAF imaging data and a second input using the OCT imaging data; fusing together the first and second input to form a fused input; and generating the lesion growth rate for the geographic atrophy lesion using the fused input.

Embodiment 4: The method of any of Embodiments 1-3, further comprising: extracting a biomarker from the fused input.

Embodiment 5: The method of Embodiment 4, wherein the biomarker comprises lesion perimeter, lesion shape-descriptive features, wedge-shaped subretinal hyporeflectivity, retinal pigment epithelium (RPE) attenuation and disruption, hyper-reflective foci, reticular pseudodrusen (RPD), multi-layer thickness reduction, photoreceptor atrophy, hypo-reflective cores in drusen, high central drusen volume, surrounding abnormal autofluorescence patterns, previous GA progression rate, outer-retinal tubulation, choriocapillaris flow void, GA lesion size, GA distance to fovea, lesion contiguity, or a combination thereof.

Embodiment 6: The method of any of Embodiments 1-5, wherein predicting the lesion growth rate further comprises: generating a first input using the set of FAF images and a second input using the set of OCT images; extracting a first feature of interest from the FAF imaging data; extracting a second feature of interest from the OCT imaging data; fusing together the first feature of interest and the second feature of interest to form a fused feature input; and generating the lesion growth rate for the geographic atrophy lesion using the fused feature input.

Embodiment 7: The method of Embodiment 6, wherein the retina is associated with a patient, the method further comprising: receiving clinical factor data associated with the patient; fusing together the clinical factor data with the first feature of interest and the second feature of interest to form the fused feature input; and generating the lesion growth rate for the geographic atrophy lesion using the fused feature input.

Embodiment 8: The method of Embodiment 7, wherein the clinical factor data includes a subject's age, sex, smoking status, an observed GA lesion area, a distance of an observed GA lesion to a foveal center of the retina, image contiguity, a best-corrected visual acuity (BCVA) score, a low-luminance deficit (LLD) score, or a combination thereof.

Embodiment 9: The method of any of Embodiments 6-8, wherein the fused feature input is formed using a model comprising an average pooling method, a squeeze and excitation method, or a combination thereof.

Embodiment 10: The method of any of Embodiments 1-9, further comprising: receiving infrared (IR) imaging data of the retina; and predicting, a lesion growth rate for a geographic atrophy lesion in the retina using the FAF imaging data, the OCT imaging data, and the IR imaging data.

Embodiment 11: The method of any of Embodiments 3-10, further comprising: pre-processing the FAF imaging data to form the first input, the pre-processing including macular field FAF image selection, region of interest extraction, image contrast adjustment, or multi-field FAF image combination.

Embodiment 12: The method of any of Embodiments 3-11, further comprising: pre-processing the OCT imaging data to form the second input, the pre-processing comprising: generating a set of en-face maps above a retinal membrane and below the retinal membrane; and predicting the lesion growth rate for the GA lesion using the generated set of en-face maps.

Embodiment 13: A system, comprising: a non-transitory memory; and a hardware processor coupled with the non-transitory memory and configured to read instructions from the non-transitory memory to cause the system to perform operations comprising: receiving fundus autofluorescence (FAF) imaging data of a retina; receiving optical coherence tomography (OCT) imaging data of the retina; and predicting a lesion growth rate for a geographic atrophy (GA) lesion in the retina using the FAF and OCT imaging data.

Embodiment 14: The system of Embodiment 13, wherein the processor is configured to perform operations further comprising: predicting a baseline lesion area for the GA lesion using the FAF and OCT imaging data.

Embodiment 15: The system of Embodiments 13 or 14, wherein predicting the lesion growth rate further comprises: generating a first input using the FAF imaging data and a second input using the OCT imaging data; fusing together the first and second input to form a fused input; and generating the lesion growth rate for the geographic atrophy lesion using the fused input.

Embodiment 16: The system of Embodiment 15, wherein the processor is configured to perform operations further comprising: extracting a biomarker from the fused data.

Embodiment 17: The system of any of Embodiments 13-16, wherein predicting the lesion growth rate comprises: generating a first input using the set of FAF images and a second input using the set of OCT images; extracting a first feature of interest from the FAF imaging data, and a second feature of interest from the OCT imaging data; fusing together the first feature of interest and the second feature of interest to form a fused feature input; and generating the lesion growth rate for the geographic atrophy lesion using the fused feature input.

Embodiment 18: The system of Embodiment 17, wherein the retina is associated with a patient, and the processor is configured to perform operations further comprising: receiving clinical factor data associated with the patient; fusing together the clinical factor data with the first feature of interest and the second feature of interest to form the fused feature input; and generating the lesion growth rate for the geographic atrophy lesion using the fused feature input.

Embodiment 19: The system of Embodiment 18, wherein the clinical factor data includes age, sex, smoking status, an observed GA lesion area, a distance of an observed GA lesion to a foveal center of the retina, image contiguity, a best-corrected visual acuity (BCVA) score, a low-luminance deficit (LLD) score, and a combination thereof.

Embodiment 20: The system of any of Embodiments 13-19, wherein the processor is configured to perform operations further comprising: receiving infrared (IR) imaging data of the retina; and predicting, a lesion growth rate for a geographic atrophy lesion in the retina using the FAF imaging data, the OCT imaging data, and the IR imaging data.

Embodiment 21: The system of any of Embodiments 13-20, wherein the processor is further configured to pre-process the OCT imaging data, the pre-processing comprising: flattening the OCT imaging data along the Bruch's membrane; averaging a set of en-face maps over one or more of full, above Bruch's membrane and below Bruch's membrane depths; and combining the set of en-face maps to produce a multi-channel input for predicting the lesion growth rate for the GA lesion.

Embodiment 22: A non-transitory computer-readable medium (CRM) having stored thereon computer-readable instructions executable to cause a computer system to perform operations comprising: receiving fundus autofluorescence (FAF) imaging data of a retina; receiving optical coherence tomography (OCT) imaging data of the retina; and predicting a lesion growth rate for a geographic atrophy (GA) lesion in the retina using the FAF and OCT imaging data.

Embodiment 23: The CRM of Embodiment 22, wherein the operations further comprising: predicting a baseline lesion area for the GA lesion using the FAF and OCT imaging data.

Embodiment 24: The CRM of Embodiments 22 or 23, wherein predicting the lesion growth rate further comprises: generating a first input using the FAF imaging data and a second input using the OCT imaging data; fusing together the first and second input to form a fused input; and generating the lesion growth rate for the geographic atrophy lesion using the fused input.

Embodiment 25: The CRM of any of Embodiments 22-24, wherein the operations further comprising: extracting a biomarker from the fused input.

Embodiment 26: The CRM of Embodiment 25, wherein the biomarker comprises lesion perimeter, lesion shape-descriptive features, wedge-shaped subretinal hyporeflectivity, retinal pigment epithelium (RPE) attenuation and disruption, hyper-reflective foci, reticular pseudodrusen (RPD), multi-layer thickness reduction, photoreceptor atrophy, hypo-reflective cores in drusen, high central drusen volume, surrounding abnormal autofluorescence patterns, previous GA progression rate, outer-retinal tubulation, choriocapillaris flow void, GA lesion size, GA distance to fovea, lesion contiguity, or a combination thereof.

Embodiment 27: The CRM of any of Embodiments 22-26, wherein predicting the lesion growth rate further comprises: generating a first input using the set of FAF images and a second input using the set of OCT images; extracting a first feature of interest from the FAF imaging data; extracting a second feature of interest from the OCT imaging data; fusing together the first feature of interest and the second feature of interest to form a fused feature input; and generating the lesion growth rate for the geographic atrophy lesion using the fused feature input.

Embodiment 28: The CRM of Embodiment 27, wherein the retina is associated with a patient, the method further comprising: receiving clinical factor data associated with the patient; fusing together the clinical factor data with the first feature of interest and the second feature of interest to form the fused feature input; and generating the lesion growth rate for the geographic atrophy lesion using the fused feature input.

Embodiment 29: The CRM of Embodiment 28, wherein the clinical factor data includes a subject's age, sex, smoking status, an observed GA lesion area, a distance of an observed GA lesion to a foveal center of the retina, image contiguity, a best-corrected visual acuity (BCVA) score, a low-luminance deficit (LLD) score, or a combination thereof.

Embodiment 30: The CRM of any of Embodiments 27-29, wherein the fused feature input is formed using a model comprising an average pooling method, a squeeze and excitation method, or a combination thereof.

Embodiment 31: The CRM of any of Embodiments 22-30, wherein the operations further comprising: receiving infrared (IR) imaging data of the retina; and predicting, a lesion growth rate for a geographic atrophy lesion in the retina using the FAF imaging data, the OCT imaging data, and the IR imaging data.

Embodiment 32: The CRM of any of Embodiments 24-31, wherein the operations further comprising: pre-processing the FAF imaging data to form the first input, the pre-processing comprising: resizing the FAF imaging data to 512×512 pixels, and normalizing the FAF imaging data between 0 and 1.

Embodiment 33: The CRM of any of Embodiments 24-32, wherein the operations further comprising: pre-processing the OCT imaging data to form the second input, the pre-processing comprising: flattening the OCT imaging data along the Bruch's membrane; averaging a set of en-face maps over one or more of full, above Bruch's membrane and below Bruch's membrane depths; and combining the set of en-face maps to produce a multi-channel OCT input for predicting the lesion growth rate for the GA lesion.

Embodiment 34: A method for evaluating geographic atrophy in a retina, the method comprising: receiving a set of fundus autofluorescence (FAF) images of the retina; receiving a set of optical coherence tomography (OCT) images of the retina; and predicting, via a machine learning system, a lesion growth rate for a geographic atrophy lesion in the retina using the set of FAF images and the set of OCT images.

Embodiment 35: The method of Embodiment 34, wherein predicting, via the machine learning system, the lesion growth rate comprises: predicting a baseline lesion area for the geographic atrophy lesion.

Embodiment 36: The method of Embodiments 34 or 35, wherein predicting, via the machine learning system, the lesion growth rate comprises: generating a first input using the set of FAF images and a second input using the set of OCT images; fusing together the first input and the second input to form a fused input; and generating an annualized lesion growth rate for the geographic atrophy lesion using the fused input.

Embodiment 37: A method for evaluating geographic atrophy in a retina, the method comprising: receiving a set of fundus autofluorescence (FAF) images of the retina; receiving a set of infrared (IR) images of the retina; and predicting, via a machine learning system, a lesion growth rate for a geographic atrophy lesion in the retina using the set of FAF images and the set of IR images.

Embodiment 38: The method of Embodiment 37, wherein predicting, via the machine learning system, the lesion growth rate comprises: predicting a baseline lesion area for the geographic atrophy lesion.

1. A method comprising:
receiving fundus autofluorescence (FAF) imaging data of a retina;
receiving optical coherence tomography (OCT) imaging data of the retina; and
predicting a lesion growth rate for a geographic atrophy (GA) lesion in the retina using the FAF and OCT imaging data.

2. The method of claim 1, further comprising:
predicting a baseline lesion area for the GA lesion using the FAF and OCT imaging data.

3. The method of claim 1, wherein predicting the lesion growth rate further comprises:
generating a first input using the FAF imaging data and a second input using the OCT imaging data;
fusing together the first and second input to form a fused input; and
generating the lesion growth rate for the geographic atrophy lesion using the fused input.

4. The method of claim 3, further comprising:
extracting a biomarker from the fused input.

5. The method of claim 4, wherein the biomarker comprises lesion perimeter, lesion shape-descriptive features, wedge-shaped subretinal hyporeflectivity, retinal pigment epithelium (RPE) attenuation and disruption, hyper-reflective foci, reticular pseudodrusen (RPD), multi-layer thickness reduction, photoreceptor atrophy, hypo-reflective cores in drusen, high central drusen volume, surrounding abnormal autofluorescence patterns, previous GA progression rate, outer-retinal tubulation, choriocapillaris flow void, GA lesion size, GA distance to fovea, lesion contiguity, or a combination thereof.

6. The method of claim 1, wherein predicting the lesion growth rate further comprises:
generating a first input using the set of FAF images and a second input using the set of OCT images;
extracting a first feature of interest from the FAF imaging data;
extracting a second feature of interest from the OCT imaging data;
fusing together the first feature of interest and the second feature of interest to form a fused feature input; and
generating the lesion growth rate for the geographic atrophy lesion using the fused feature input.

7. The method of claim 6, wherein the retina is associated with a patient, the method further comprising:
receiving clinical factor data associated with the patient;
fusing together the clinical factor data with the first feature of interest and the second feature of interest to form the fused feature input; and
generating the lesion growth rate for the geographic atrophy lesion using the fused feature input.

8. The method of claim 7, wherein the clinical factor data includes a subject's age, sex, smoking status, an observed GA lesion area, a distance of an observed GA lesion to a foveal center of the retina, image contiguity, a best-corrected visual acuity (BCVA) score, a low-luminance deficit (LLD) score, or a combination thereof.

9. The method of claim 5, wherein the fused feature input is formed using a model comprising an average pooling method, a squeeze and excitation method, or a combination thereof.

10. The method of claim 1, further comprising:
receiving infrared (IR) imaging data of the retina; and
predicting, a lesion growth rate for a geographic atrophy lesion in the retina using the FAF imaging data, the OCT imaging data, and the IR imaging data.

11. The method of claim 3, further comprising:
pre-processing the FAF imaging data to form the first input, the pre-processing including macular field FAF image selection, region of interest extraction, image contrast adjustment, or multi-field FAF image combination.

12. The method of claim 3, further comprising:
pre-processing the OCT imaging data to form the second input, the pre-processing comprising:
generating a set of en-face maps above a retinal membrane and below the retinal membrane; and
predicting the lesion growth rate for the GA lesion using the generated set of en-face maps.

13. A system, comprising:
a non-transitory memory; and
a hardware processor coupled with the non-transitory memory and configured to read instructions from the non-transitory memory to cause the system to perform operations comprising:
receiving fundus autofluorescence (FAF) imaging data of a retina;
receiving optical coherence tomography (OCT) imaging data of the retina; and
predicting a lesion growth rate for a geographic atrophy (GA) lesion in the retina using the FAF and OCT imaging data.

14. The system of claim 13, wherein the processor is configured to perform operations further comprising:
predicting a baseline lesion area for the GA lesion using the FAF and OCT imaging data.

15. The system of claim 13, wherein predicting the lesion growth rate further comprises:
generating a first input using the FAF imaging data and a second input using the OCT imaging data;
fusing together the first and second input to form a fused input; and
generating the lesion growth rate for the geographic atrophy lesion using the fused input.

16. The system of claim 15, wherein the processor is configured to perform operations further comprising:
extracting a biomarker from the fused data.

17. The system of claim 13, wherein predicting the lesion growth rate comprises:
generating a first input using the set of FAF images and a second input using the set of OCT images;
extracting a first feature of interest from the FAF imaging data, and a second feature of interest from the OCT imaging data;
fusing together the first feature of interest and the second feature of interest to form a fused feature input; and
generating the lesion growth rate for the geographic atrophy lesion using the fused feature input.

18. The system of claim 17, wherein the retina is associated with a patient, and the processor is configured to perform operations further comprising:
receiving clinical factor data associated with the patient;
fusing together the clinical factor data with the first feature of interest and the second feature of interest to form the fused feature input; and
generating the lesion growth rate for the geographic atrophy lesion using the fused feature input.

19. The system of claim 18, wherein the clinical factor data includes age, sex, smoking status, an observed GA lesion area, a distance of an observed GA lesion to a foveal center of the retina, image contiguity, a best-corrected visual acuity (BCVA) score, a low-luminance deficit (LLD) score, and a combination thereof.

20. The system of claim 13, wherein the processor is configured to perform operations further comprising:
receiving infrared (IR) imaging data of the retina; and
predicting, a lesion growth rate for a geographic atrophy lesion in the retina using the FAF imaging data, the OCT imaging data, and the IR imaging data.

21. The system of claim 13, wherein the processor is further configured to pre-process the OCT imaging data, the pre-processing comprising:
flattening the OCT imaging data along the Bruch's membrane;
averaging a set of en-face maps over one or more of full, above Bruch's membrane and below Bruch's membrane depths; and
combining the set of en-face maps to produce a multi-channel input for predicting the lesion growth rate for the GA lesion.

22. A non-transitory computer-readable medium (CRM) having stored thereon computer-readable instructions executable to cause a computer system to perform operations comprising:
receiving fundus autofluorescence (FAF) imaging data of a retina;
receiving optical coherence tomography (OCT) imaging data of the retina; and
predicting a lesion growth rate for a geographic atrophy (GA) lesion in the retina using the FAF and OCT imaging data.
